(19) United States
(12) Patent Application Publication
(10) Pub. No.: US 2013/0304587 A1
(43) Pub. Date: Nov. 14, 2013

(54) SYSTEM AND METHOD FOR INTERACTIVE COMMUNICATIONS WITH ANIMATION, GAME DYNAMICS, AND INTEGRATED BRAND ADVERTISING

(71) Applicant: Yosot, Inc., Portola Valley, CA (US)

(72) Inventor: John D. Ralston, Portola Valley, CA (US)

(21) Appl. No.: 13/875,258

(22) Filed: May 1, 2013

Related U.S. Application Data
(60) Provisional application No. 61/640,908, filed on May 1, 2012.

(51) Int. Cl. G06Q 30/02

(52) U.S. Cl. CPC G06Q 30/0271
USPC 705/14.67

(57) ABSTRACT

The system and methods described herein provide for advocating brands in a multimedia device applications. The system and method provides for conversion of digital facial images into animated representations. The system and method captures and analyzes a user's voice information, compares this to a plurality of phonemes, maps the extracted phonemes onto the animated representation allowing for synchronized movement of the animated representation with real time voice conversations therefore providing for a low-bandwidth video chat capability. The system and method also provide a method for advertisers to target users and bid online to deliver users branded display backdrops, logos or multimedia content. The system and method couples advertiser bids and display prominence so that the higher the bid, the more prominent is the presentation of a advertiser's thumbnail, icon or other representation of the advertiser's user engagement content offering in a list displayed on a target user's multimedia device.

### CROSS-REFERENCE TO RELATED APPLICATIONS

This claims priority to U.S. Provisional Patent Application No. 61/640,908 to Ralston, filed on May 1, 2012, the entirety of which is incorporated herein by reference.

### FIELD OF THE INVENTION

Embodiments of the disclosed system and method relate generally to mobile communications and advertising. More particularly, the embodiments of the disclosed system and method relate to electronic devices, computer program products, methods, and systems with which interactions between mobile device users, and the engagement between mobile device users and brand advertisers, are enhanced using animation, game design techniques, game mechanics, and integrated brand advertising in order to eliminate technical and psychological impediments to user and market adoption, and to enable a greater degree of interaction between mobile subscribers and advertisers/content providers by turning mobile interaction into a game and turning users into brand advocates.

Terms and Concepts Related to Embodiments of the Disclosed System and Method.

Enhancing real-time mobile interaction using animation, game design techniques, game mechanics, and integrated brand advertising.

System and method for enabling Brand Advocacy to be implemented simultaneously as a Mobile Social Game (for users) and Service (for brands, advertisers, and other content providers), herein referred to as BAMSGaS.

BAMSGaS Client application program and Network Connectivity infrastructure platform enable users to interact with each other face-to-face, in real-time or in non-real-time, and to engage with brand advertisers and other content providers, via mobile devices operating on mobile networks using voice communications combined with Animated User RepresentAtions (AURAs).

BAMSGaS Account Management and “Pay-for-Prominence” Bidding platform and service enable advertisers and other content providers to select a set of target users and bid in an online competitive process to deliver branded display backdrops, AURAs, AURA features, audio backgrounds, or other multimedia content for target users to display together with the AURAs.

Each advertiser bid is specific to a combination of target user criteria and display backdrop/other multimedia content being offered to the target users.

The higher the bid, the more prominent is the presentation an icon representing the advertiser's display backdrop (or other multimedia content) in a list displayed on target users' devices (prominence=icon position or rank in a list presented to the user; the size of the icon; the presentation of the icon in color vs. black & white; or some other similar attribute). Hence the term Pay-for-Prominence.

Each bid corresponds to a money amount that the advertiser/content provider will pay to the owner of the Pay-for-Prominence service each time a user of the BAMSGaS service clicks on the advertiser's icon and retrieves the corresponding display backdrop, AURA, or other multimedia content.

Advertisers are charged based on numbers of users selecting their display back-drop or AURA, along with the cumulative display time on targeted users' devices.

### BACKGROUND

Applications and services enabling interactions between mobile device users, and the engagement between mobile device users and brand advertisers, are rapidly being embraced by users of mobile devices and networks. This trend can be seen in both communication services, where video is finally becoming a viable alternative to voice and text, as well as in consumption of various entertainment, gaming, social networking, and information services, where mobile consumers increasingly expect to be able to view the same interactive multimedia content that they have become accustomed to in fixed environments. For mobile operators, interactive video represents a significant dilemma. On one hand, consumer demand for both communication in and consumption of video is evidently great, but on the other hand, video is an extremely data-heavy activity and burdens the network infrastructure accordingly.

Mobile operators and over-the-top (OTT) service providers have developed and deployed a multitude of mobile video calling, video chat, and video conferencing services, but fundamental technical and psychological barriers have prevented all of these face-to-face interaction services from becoming “sticky” or profitable.

On the technical side, all of the above 2-way and multi-party real-time mobile services have been built and deployed using bandwidth-heavy broadcast industry video technologies. Deploying these standard broadcast solutions over the much lower available bandwidths and much greater network fluctuations (jitter, delay, packet loss) that characterize even 4G mobile networks delivers a widely variable, difficult to predict/control, and generally poor user experience. Large numbers of users typically flock to every new free service launch, but no service to date has been able to follow up with a premium service that has attracted a sufficient base of dedicated or paying users to show a convincing path to profitability.

On the psychological side, little attention has been paid to the fact that the vast majority of potential customers for such services—across a wide range of demographics—have a fundamental reluctance to participate in real-time viewing and sharing of photo-realistic “where I am and what I look like” videos. Furthermore, in stark contrast to the commercial video content that users happily consume, the generally poor lighting, tiny cameras, and lack of makeup and background sets that characterize real-time video sharing on smartphones, together with the fact that most users are not trained actors, often leads to significant discomfort while participating. Expectations that mobile video chat is low-quality, poorly controlled, and uncomfortable to use also leads to a general reluctance to pay for these services. Finally, the vast majority of advertisers, brand owners, and other content providers do not want their brands or content displayed alongside uncontrolled and unmonitored real-time user-generated video. This reluctance on the part of advertisers/content owners to offset the cost of services effectively kills the opportunity to generate meaningful advertising revenues, even if a free-to-download service were to secure a large user base.

### SUMMARY

Embodiments of the disclosed system and method described here seek to address the aforementioned problems by providing methods and systems for enabling mobile user interaction to be enhanced using animation, game design techniques, game mechanics, and integrated brand advertising in order to eliminate the fundamental technical and psychological impediments highlighted above, and to enable a greater degree of interaction between mobile subscribers using various network connected devices and advertisers/content providers using a computer network, by turning face-to-face mobile interaction into a game and turning users into brand advocates.

More specifically, embodiments of the disclosed system and method described here relate to systems and methods for enabling Brand Advocacy to be implemented simultaneously as a Mobile Social Game (for users) and Service (for brands, advertisers, and other content providers), herein referred to as BAMSGaS.

Embodiments of the disclosed system and method relate to systems and methods that include a BAMSGaS Client application program and a Network Connectivity infrastructure platform to enable users to interact with each other face-to-face, in real-time or in non-real-time, and to engage with brand advertisers and other content providers, via mobile devices operating on mobile networks using voice communications combined with Animated User RepresentAtions (AURAs). Various embodiments also enable users to manipulate features of their own or each other's AURAs, or the display backdrops on which the AURAs are presented on the users' devices. Various embodiments also enable users to allow the BAMSGaS system to automatically manipulate features of their own or each other's AURAs, or the display backdrops on which the AURAs are presented on the users' devices.

Embodiments of the disclosed system and method further relate to systems and methods that include a BAMSGaS Account Management and Pay-for-Prominence Bidding platform to enable an advertiser or other content provider to: select a set of target user metrics or criteria relevant to the advertiser's or content provider's products or services; define a branded display backdrop and/or AURA and an icon representing the branded display backdrop and/or AURA; present the icon to a targeted user during a real-time interaction session via a list displayed on the user's device; influence the prominence of the presentation of the icon on the list displayed on the devices of users who meet the selected user metrics or criteria; and deliver the branded display backdrop, AURA, and other multimedia content to be displayed along with the AURA on the devices of users who click on the icon.

In one embodiment of the disclosed system and method, an advertiser or other content provider selects one or more criterion or metrics that define the users they wish to target (examples include but are not limited to: country, state, zip code, area code, wireless carrier, handset operating system, handset model, geo-location, other demographic options, or other contextual options) and influences the prominence of the presentation of an icon within a list of icons displayed on devices of the targeted users by participating in an online competitive bidding process. This online competitive bidding process is referred to here as a “Pay-for-Prominence” process, and may be employed in conjunction with a user interaction/brand engagement service. When a user activates the service via the application on their mobile device, the Pay-for-Prominence engine may generate a list of thumbnail icons representing advertisers'/content providers' multimedia offerings that target the user based upon one or more target user parameters defined by the advertisers/content providers. In various embodiments of the disclosed system and method, the level of prominence of presentation of the thumbnail icons, or representation in another format, may be determined by one or more attributes, including but not limited to the following: The position on a scrollable list displayed on a targeted user's device; the position in a continuously scrolling list displayed on a targeted user's device; the speed at which the advertiser's thumbnail scrolls in a continuously scrolling list displayed on a targeted user's device; the size of the advertiser's thumbnail; presentation of colored vs. grey-scale or black and white versions of the advertiser's thumbnail.

“Pay-for-Prominence” applies animation, game design techniques, and game mechanics to enhance the effectiveness of mobile advertising by converting users of the AURA interaction service into brand advocates. Conventional mobile advertising/content delivery platforms and services do not provide a way for advertisers and content providers to integrate advertising and other content into the display backdrops and AURAs of users who are interacting with each other using their mobile devices. A tool enabling advertisers/content providers to target users via metrics or criteria relevant to their business, products, or services, and to influence the prominence of the presentation of their content offerings within lists displayed on targeted users' devices provides a powerful advantage to businesses and others seeking to increase their engagement with mobile users. Furthermore, a competitive bidding process and pricing based on the number of users who select a brand's multimedia offering and the cumulative viewing time of each such offering on targeted users' devices helps to ensure that the pricing structure reflects the market and is accessible to advertisers of all budget sizes.

To participate in the process, a mobile user may access their own user account through the BAMSGaS client application program on their mobile device. The user may use their account to establish a real-time or non-real-time interaction session with one or more other users on a mobile network using voice communications combined with AURAs.

To participate in the process, an advertiser or other content provider may access their own user account through a secure web site. The advertiser/content provider may use their user account to place bids on criteria or metrics that define the users they wish to target. Each bid is specific to a combination of user criteria and display backdrop and corresponds to a money amount that the advertiser/content provider will pay to the owner of the Pay-for-Prominence service each time a mobile user clicks on the advertiser's thumbnail icon in the list generated on their mobile device by the Pay-for-Prominence engine. The mobile user's click will result in an access request being sent to the advertiser's/content provider's web content server, which will respond by transmitting the advertiser's/content provider's branded display backdrop, AURA, or other multimedia content to the mobile user's device. The selected branded content will then be displayed on the users' devices during their interactive session. The charge to the advertiser/content provider for the placement is therefore directly proportional to the benefit received, since the charge is based on the number of users who select the advertiser's/content provider's branded content from the list generated on their devices by the Pay-for-Prominence engine, and the cumulative viewing time on targeted users' devices.

The higher the bid, the more prominent is the presentation of the thumbnail icon in the display list result that is generated when the bidded user criteria are entered by an advertiser/content provider using the Pay-for-Prominence engine. The display list result is arranged in order of decreasing bid amount, with the display list entries corresponding to the highest bids displayed more prominently to the mobile user. Each display list entry corresponding to a bid may be identified on the display as a paid listing.

According to one embodiment of the disclosed system and method, systems and methods are provided for enabling mobile subscribers to establish a real-time or non-real-time interaction session combining voice communications and AURAs, and for simultaneously enabling advertisers/content providers to influence the prominence of a display listing within a display list result generated by a Pay-for-Prominence engine and displayed on the mobile subscribers' devices during the interaction session. The advertiser/content provider first defines targeted users by entering one or more user criteria or metrics relevant to the product or service to be promoted. The advertiser/content provider influences the rank position and/or other measure of prominence for the display listing through an ongoing online competitive bidding process with other advertiser/content providers. The bidding process occurs each time an advertiser/content provider enters a new bid amount for an existing combination of target users plus display listing or enters a bid amount for a new combination of target users plus display listing. The advertiser's/content provider's bid may then be processed in real time. This bid amount is compared with all other bid amounts from other advertisers/content providers for the same target users, and generates new rank values for all target user listings having those user criteria. The rank value determines the prominence with which the advertiser's/content provider's backdrop listing will appear on the display list result that is generated and displayed on the devices of users matching the target criteria when the users initiate an interaction session using their AURAs. A higher bid will result in a higher rank value and a more advantageous placement or presentation, such as nearer the top of a scrollable list displayed on target users' devices. The quantity used in the competitive bidding process may be a money amount that the advertiser/content provider will pay to the owner of the Pay-for-Prominence service each time the advertiser's/content provider's branded content is selected and utilized. This money amount may be deducted from an account balance that is retained in the advertiser's/content provider's account.

One embodiment provides a database having accounts for each advertiser or other content provider. Each account includes contact and billing information for an advertiser/content provider. In addition, each account includes at least one target user listing, each target user listing having components that include, but are not limited to, the following: a thumbnail, icon, or other representation of the display backdrop, AURA, or other branded content to be offered to the target users; the Uniform Resource Locator (URL) of the corresponding branded content on the advertiser/content provider web server; a target user listing comprising one or more user metrics or criteria; a bid amount; and a title for the target user/branded content listing combination.

Each account may also include the advertiser's/content provider's payment history and a history of target user listings that have been entered. An advertiser/content provider logs into his or her account via an authentication process running on a secure server. Once logged in, the advertiser/content provider may add, delete, or modify a target user listing. The functions of adding or deleting a target user listing, or modifying the bid amount for a target user listing, will initiate the competitive bidding process described above. All target user listing changes and modifications are processed substantially in real time to support the online competitive bidding process.

### BRIEF DESCRIPTION OF THE DRAWINGS

To facilitate further description of the embodiments, the following drawings are provided in which:

FIG. 1 shows functional steps for low-computational-complexity and low-bitrate real-time user interaction with face extraction, face animation, and display backdrop.

FIG. 2 shows an example of a user-created AURA, or “AURA”.

FIG. 3A shows an example of low-computational-complexity and low-bitrate real-time user interaction with AURAs and brand-supported display backdrops.

FIG. 3B illustrates one embodiment of a low-computational-complexity and low bitrate non-real-time animated messaging session with AURAs and brand-supported display backdrops.

FIG. 4A shows an example of a game mode in which advertisers present brands and users select brand-supported display backdrops.

FIG. 4B shows a further example of a game mode in which advertisers present brands and users select brand-supported display backdrops.

FIG. 5A shows an example of an alternative game mode in which advertisers present brands and users select brand-supported display backdrops.

FIG. 5B shows a further example of an alternative game mode in which advertisers present brands and users select brand-supported display backdrops.

FIG. 6 shows an example of a game mode in which users can manipulate features of each other's AURAs.

FIG. 7 shows an example of a game mode in which the game application automatically manipulates features of a user's AURA in order to enable brand advocacy.

FIG. 8 shows an example of a game mode in which a user can enable brand advocacy as a feature of their AURA.

FIG. 9 shows an example of a game mode in which brand advocacy is enabled as an audio background or soundtrack.

FIG. 10 shows examples of different game mechanics that can be incorporated into various embodiments of the disclosed system and method.

FIG. 11 shows an example of a user immersed in a video game display backdrop using their AURA.

FIG. 12 shows an example of multiple users interacting with each other by having their AURAs displayed in a multi-party conferencing format while playing a video game that serves as the display backdrop during a real-time interaction session.

FIG. 13 shows an example of multiple users interacting with each other by having their AURAs displayed while viewing a live or recorded video broadcast program that serves as the display backdrop during a real-time interaction session.

FIG. 14 shows an example of users interacting with each other by having their AURAs displayed during shared reading of an electronic book.

FIG. 15 shows an example of low-computational-complexity real-time identification and tracking of face and facial features.

FIG. 16 shows an example of a mask used to determine the outline of a face for animation.

FIG. 17 shows an example of real-time identification and tracking of detailed facial features.

FIG. 18 shows an example of a 3D head mesh model.

FIG. 19 shows an example of the placement of 2D facial features extracted from a photograph onto 2D and 3D head mesh models.

FIG. 20 shows examples of 3D head mesh models with different node and polygon densities.

FIG. 21 shows examples of modifying and adding features on AURAs of users.

FIG. 22 shows an example of animating the mouth on an animated user representation by synchronizing to phonemes extracted from the user's voice received on another user's device.

FIG. 23A shows examples of original faces and AURAs for different frames in a video sequence.

FIG. 23B illustrates a mapping of a user's speech to a fixed set of phonemes, and a corresponding mapping of phonemes to a fixed set of AURA facial expressions, or visemes, in one embodiment of the disclosed system and method.

FIG. 23C illustrates a mapping of a fixed set of phonemes extracted from a user's voice to a fixed set of AURA facial expressions, or visemes, in one embodiment of the disclosed system and method.

FIG. 23D further illustrates a mapping of a fixed set of phonemes extracted from a user's voice to a fixed set of AURA facial expressions, or visemes, in one embodiment of the disclosed system and method.

FIG. 23E further illustrates a mapping of a fixed set of phonemes extracted from a user's voice to a fixed set of AURA facial expressions, or visemes, in one embodiment of the disclosed system and method.

FIG. 23F shows an example sequence of viseme identifiers utilized along with corresponding time stamps relative to a user's voice signal to render a set of AURA facial expressions onto a corresponding display background in synchronism with the user's voice signal, in one embodiment of the disclosed system and method. This Figure depicts Viseme 1 (Display background, “silence”).

FIG. 23G shows an example sequence of viseme identifiers utilized along with corresponding time stamps relative to a user's voice signal to render a set of AURA facial expressions onto a corresponding display background in synchronism with the user's voice signal, in one embodiment of the disclosed system and method. This Figure depicts Viseme 11.

FIG. 23H shows an example sequence of viseme identifiers utilized along with corresponding time stamps relative to a user's voice signal to render a set of AURA facial expressions onto a corresponding display background in synchronism with the user's voice signal, in one embodiment of the disclosed system and method. This Figure depicts Viseme 13.

FIG. 23I shows an example sequence of viseme identifiers utilized along with corresponding time stamps relative to a user's voice signal to render a set of AURA facial expressions onto a corresponding display background in synchronism with the user's voice signal, in one embodiment of the disclosed system and method. This Figure depicts Viseme 14.

FIG. 24 shows a block diagram illustrating one embodiment of the client application according to the disclosed system and method.

FIG. 25 shows a block diagram of an IMS deployment of a real-time interaction network connectivity infrastructure platform, in one embodiment of the disclosed system and method.

FIG. 26 shows a block diagram of an OTT cloud-based deployment of a real-time interaction network connectivity infrastructure platform, in one embodiment of the disclosed system and method.

FIG. 27 shows a block diagram illustrating the relationship between a large network and one embodiment of a system and method for generating a Pay-for-Prominence bidding result in the disclosed system and method.

FIG. 28 shows a chart of menus, display screens, and input screens used by advertisers who bid for a Pay-for-Prominence result in one embodiment of the disclosed system and method.

FIG. 29 is a diagram showing data in an advertiser's account record for use with one embodiment of the disclosed system and method.

FIG. 30 shows an example of a touch screen scrollable Pay-for-Prominence logo icon list display result generated by a Pay-for-Prominence bidding system in one embodiment of the disclosed system and method.

FIG. 31 shows an example of a click-through result generated when users in a real-time interactive session click on brand logo icons displayed as bid result list entries on their mobile devices, in order to retrieve and display the corresponding branded display backdrop content together with their AURAs.

FIG. 32 shows a flow chart illustrating a change bids process used in one embodiment of the disclosed system and method.

FIG. 33 shows an example of a screen display used in the change bids process of FIG. 32.

FIG. 34 illustrates the user interaction and brand engagement functions enabled by the BAMSGaS platform.

FIG. 35 illustrates a cloud-based platform-as-a-service deployment of the BAMSGaS platform.

FIG. 36 illustrates mobile user access to branded engagement content enabled by the BAMSGaS application and platform.

For simplicity and clarity of illustration, the drawing figures illustrate the general manner of construction of aspects of the present disclosed system and method, and descriptions and details of possible well-known features and techniques may be omitted to avoid unnecessarily obscuring the embodiments of the disclosed system and method. Additionally, elements in the drawing figures are not necessarily drawn to scale. For example, the dimensions of some of the elements in the figures may be exaggerated relative to other elements to help improve understanding of embodiments of the present disclosed system and method. The same reference numerals in different figures denote the same elements.

The terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

### DETAILED DESCRIPTION

Described below are certain embodiments of the disclosed system and method as may be illustrated in Figures attached to this application as well as the preceding and following descriptions and characterizations. The described embodiments are not limiting as to the scope of the disclosed system and method, which may include more or less particulars in each aspect of the embodiments and components of embodiments described below. Furthermore, features and capabilities of each of the components of the embodiments described may be varied and either included or not included while remaining within the scope of the disclosed system and method.

In one embodiment of the present system includes: a BAMSGaS Client application program for mobile devices such as smartphones and tablets, as well as laptops, PCs, video phones, videoconferencing or telepresence endpoints, Internet-connected televisions, and other devices with Internet data connectivity and multimedia display and communications capabilities; a Network Connectivity infrastructure platform; and a BAMSGaS Account Management and Pay-for-Prominence Bidding platform. The steps required for the system and method presently disclosed are performed in a processor contained in various multimedia devices on which the application can be run.

The BAMSGaS Client software application program can run on mobile devices such as smartphones and tablets with operating systems (OSs) such as, but not limited to, Google/Android, Apple/iOS, Microsoft/WindowsPhone, and Research in Motion/Blackberry OS. The BAMSGaS software application can be pre-installed on the mobile device prior to sale, or downloaded by a user after purchase. The BAMSGaS software application can also run on laptops, PCs, video phones, videoconferencing or telepresence endpoints, Internet-connected televisions, and other devices with Internet data connectivity and multimedia display and communications capabilities.

In one embodiment, the BAMSGaS Client application allows users to transform a photograph of a user captured by a mobile device camera into an AURA. Users can then manipulate the AURAs in many ways, including interactively and in real-time. The AURAs can then be embedded in, or displayed together with, a wide variety of well-controlled display background templates, or “backdrops”. These backdrops may include a variety of static images, video clips, and animated sequences. Information derived from the user's facial features or voice can be utilized to animate AURA facial features in synchronism with the user's voice during real-time chat or non-real-time messaging sessions, enabling a low-bandwidth alternative to face-to-face video interactions.

In another embodiment, the BAMSGaS Client application allows users to transform the sequence of natural photorealistic images captured by mobile device cameras as a video stream into face-tracked animations that users can manipulate similar to the AURAs above.

In another embodiment, the BAMSGaS Client application allows users to select pre-defined AURAs already embedded in display backdrops.

In another embodiment, the BAMSGaS Client application allows users to select branded display backdrops, AURAs, and other multimedia user engagement content offerings to display and animate during real-time chat or non-real-time messaging sessions.

The Network Connectivity infrastructure platform enables users with the BAMSGaS Client application installed on their devices to establish real-time or non-real-time interactive sessions with each other using voice communications combined with AURAs, utilizing wireless networks such as, but not limited to, 3G/4G cellular, WiFi, and Bluetooth. The Network Connectivity infrastructure platform also allows advertisers and other content providers to interact with users by providing access to brand-supported backdrops, AURAs, and other multimedia content.

The BAMSGaS Account Management and Pay-for-Prominence Bidding platform enables advertisers and other content providers to define a set of target users and bid in a competitive process to deliver branded multimedia content to be displayed on the devices of users who select such branded content to be displayed during an interaction session.

Aspects of one embodiment of the BAMSGaS client application for user interaction and user/brand engagement using mobile devices in the disclosed system and method include methods and systems for: low-computational-complexity and low-bandwidth generation of AURAs for real-time and non-real-time interaction; establishing real-time animated chat sessions between users, combining voice communications and AURAs; establishing non-real-time animated messaging sessions between users, combining voice communications and AURAs; adding game design techniques and game mechanics to real-time interaction; and adding brand-supported display backdrops, AURAs, AURA features, and other multimedia content to real-time chat and non-real-time messaging sessions.

It will be appreciated from the description below that systems and methods of the disclosed system and method may be implemented in software that is stored as executable instructions on a computer storage medium, such as memories or mass storage devices, on a user's mobile device or other device.

Image Animation, Manipulation, and Game Elements.

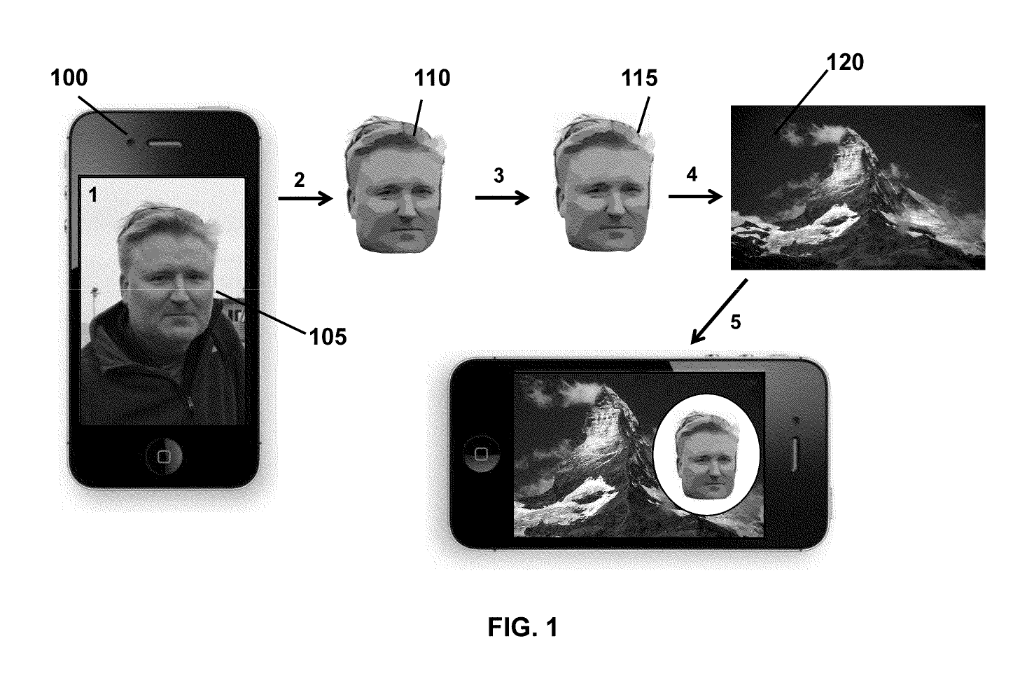

FIG. 1 illustrates functional steps for one embodiment of low-computational-complexity and low-bitrate AURA generation and user interaction, implemented as a software application running on mobile devices.

Step 1: capture natural photo 105 or video images from mobile device camera 100 (or webcam on PC);

Step 2: track and extract user's face;

Step 3: animate face to create an AURA 110;

Step 4: enable user-controlled or system-automated insertion of display backdrops 120, including branded display backdrops;

Step 5: enable interactive game design techniques and game mechanics such as user-controlled or system-automated manipulation of one or more features of the AURA.

AURAs in Step 1 above may include, but are not limited to: a 2D 110, or 3D 115, animated image of the user; a photorealistic representation of the user derived from a camera image; a face-tracked sequence of animated video images of the user derived from a camera video sequence; a cartooned representation of the user derived from a camera image or video sequence; a complete fantasy character representation not derived from a camera image or video sequence; or a representation in which facial features from the user or information derived from the user's voice are used to animate other animate or inanimate objects, including objects that may be presented to the user by embedding them in a display backdrop.

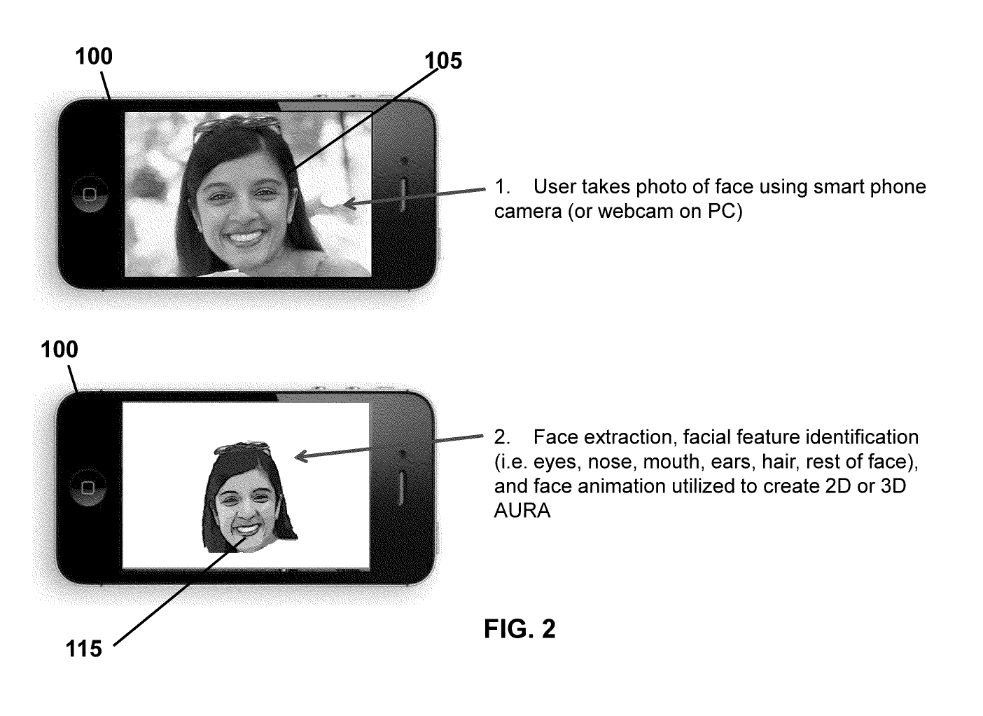

FIG. 2 illustrates functional steps for one embodiment of capturing natural photo images 105 from a mobile device 100 camera and tracking, extracting, and animating the face to create an AURA 115.

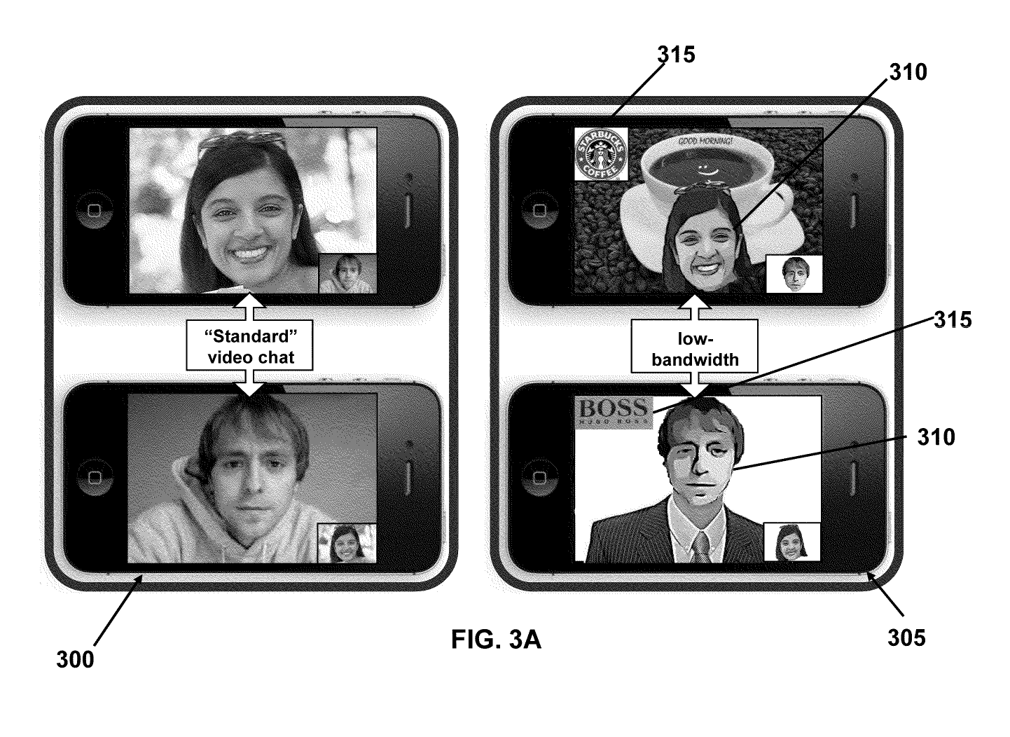

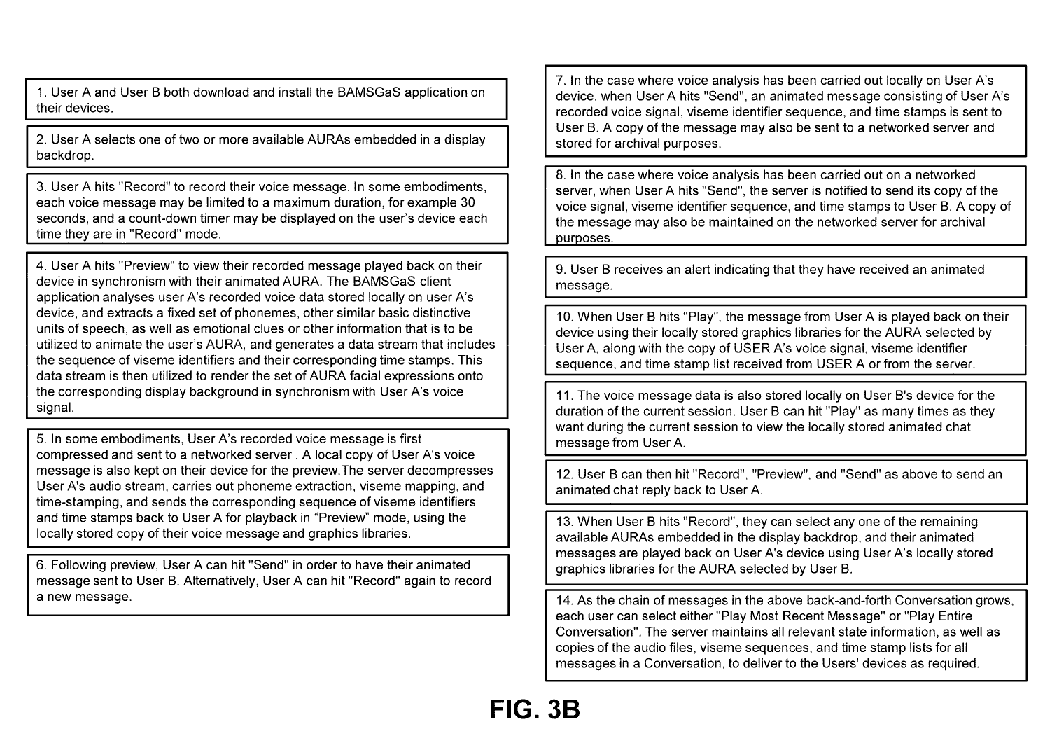

FIG. 3A illustrates some of the differences between standard video chat and the low bitrate real-time animated chat. The multimedia devices on the left 300 depicts standard video chat. The multimedia devices on the right 305 depict low bitrate real-time animated chat session with AURAs 310 and brand-supported display 315.

FIG. 3B illustrates one embodiment of a low-computational-complexity and low bitrate non-real-time animated messaging session with AURAs and brand-supported display backdrops.

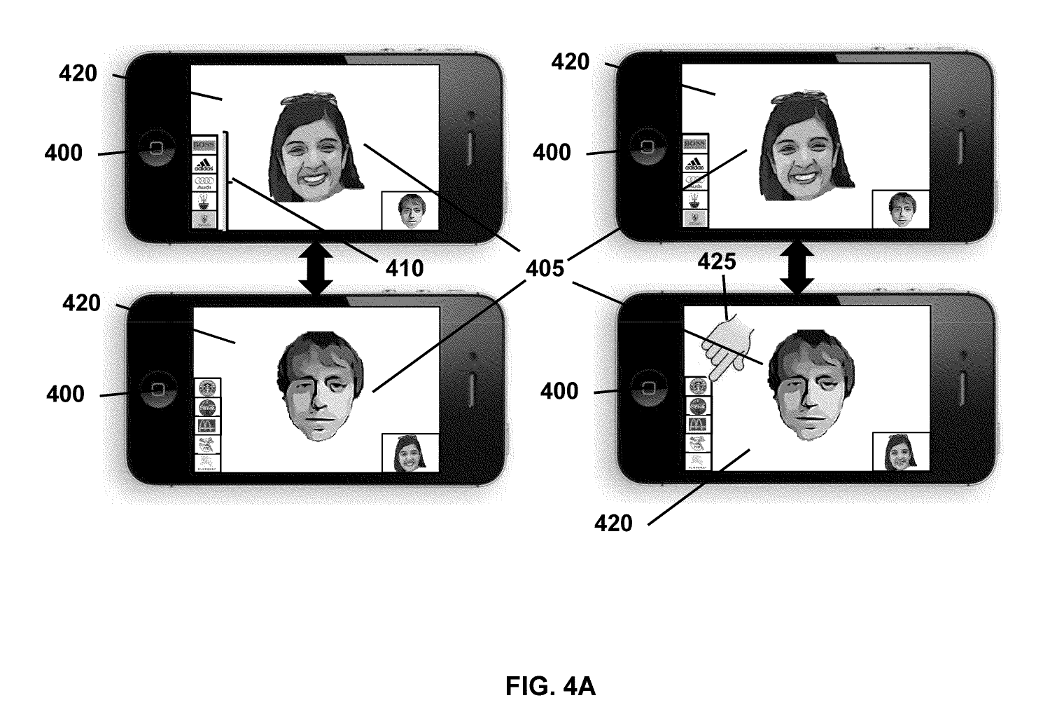

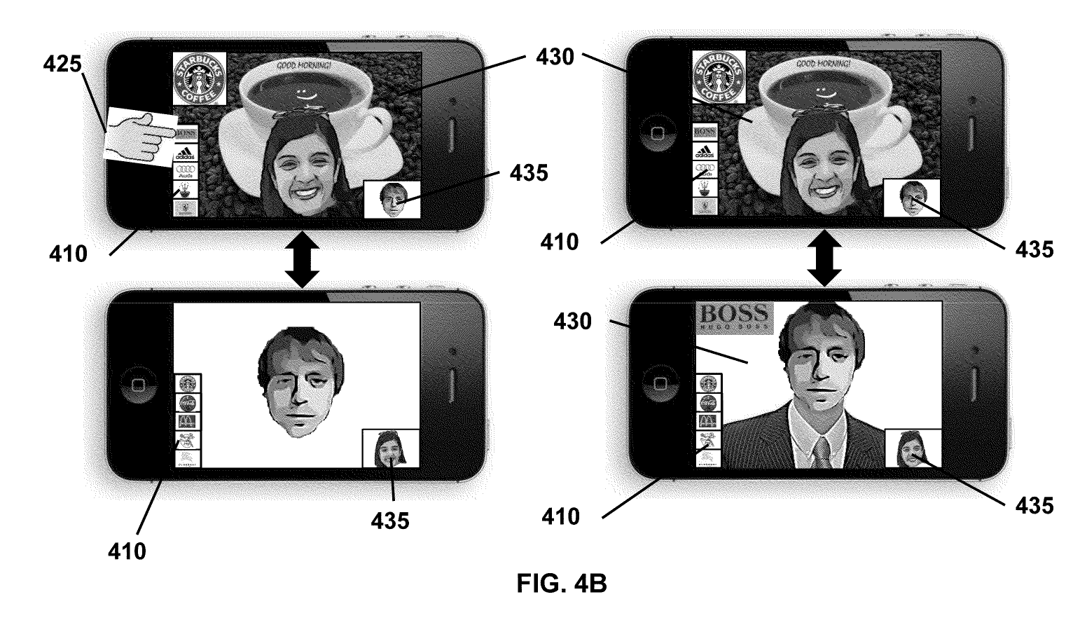

FIG. 4A illustrates one embodiment of a game mode in which AURAs 405 are displayed on multimedia devices 400 and the BAMSGaS service enables advertisers to offer branded multimedia content to users via a scrollable list 410 of logos, thumbnails, icons, or other representations, and users select branded display backdrops from the list. Each session begins with users' AURAs 405 on default display backdrop 420. Brand logos are presented as a scrollable list 410 of thumbnails, with advertisers bidding for prominence via attributes such as size of logo, placement towards the top of the list, etc. A user begins customization by clicking on a brand logo 425. FIG. 4B presents a continuation of game mode. As the user clicks on a brand logo 425 the corresponding brand-supported backdrop 430 is activated behind the user's AURA 405 (in the present example as seen by their real-time integration partner 435). Users can change their backdrops 430 by scrolling through the thumbnail list of logos and clicking on a different logo.

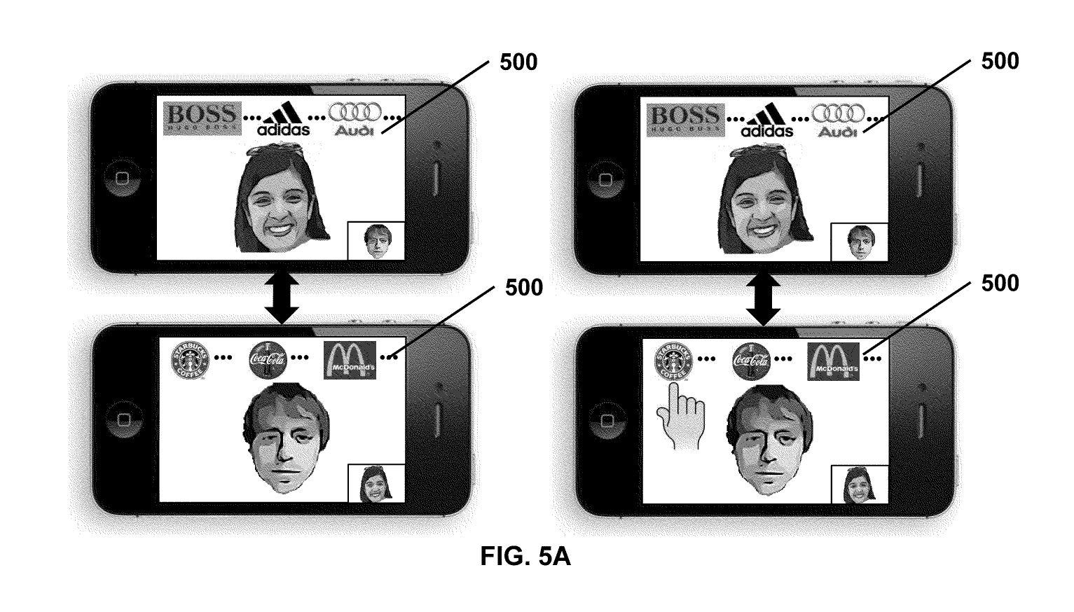

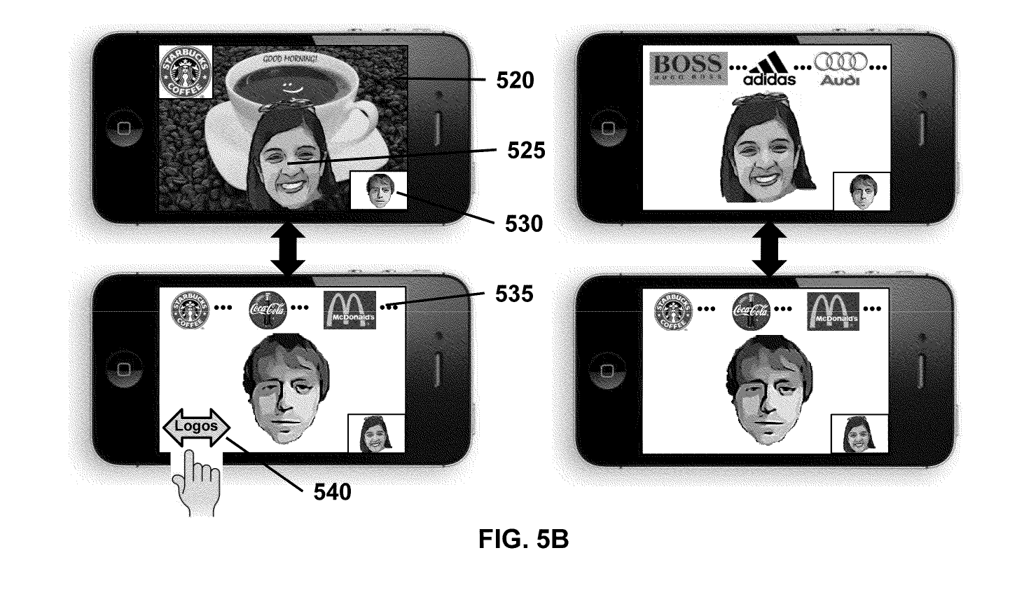

FIG. 5A illustrates another embodiment of a game mode in which the BAMSGaS service enables advertisers to offer branded multimedia content to users via a continuously scrolling list 500 of logos, thumbnails, icons, or other representations, and users select branded display backdrops from the list. A user selects a backdrop by clicking on the logo 510. FIG. 5B continues the illustration of the alternative game mode. When a user clicks on a backdrop the corresponding brand-supported backdrop is activated behind the user's AURA 525 (in this example as seen by their real-time interaction partner 530). Other logos may continue to scroll across the user's display 535, or a “resume logo scrolling” button may also be made available 540, which when clicked in this example allows users to leave the currently displayed backdrop 520 and return to the mode in which brand logos scroll across the display 500. Advertisers may be charged according to the cumulative dwell time that users spend with the advertiser's backdrop 520 active on their displays.

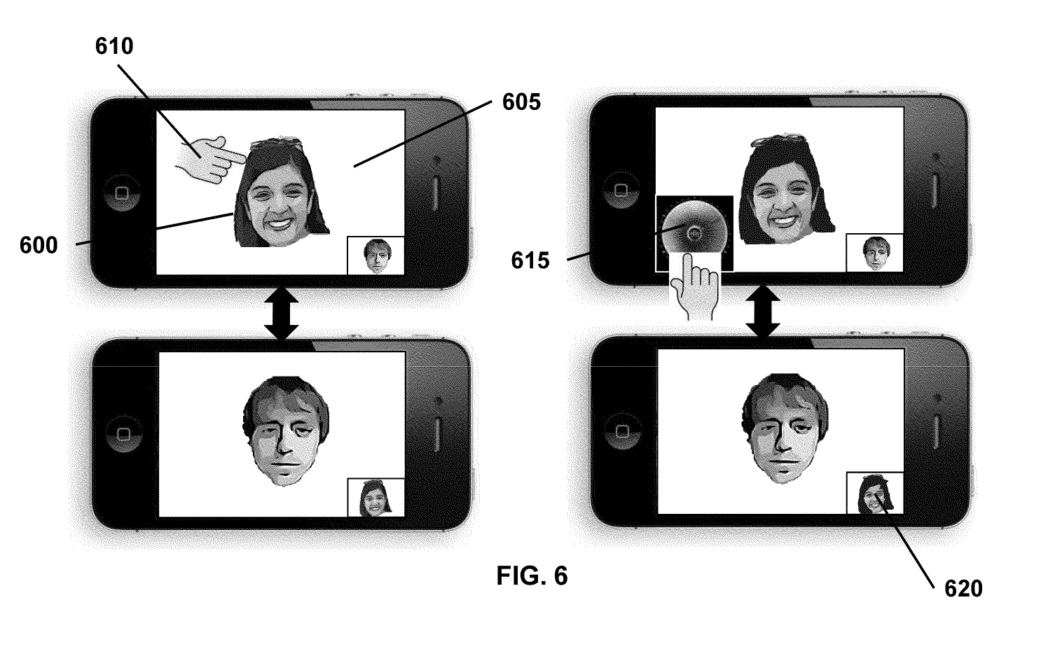

FIG. 6 illustrates an example of a game mode in which users can manipulate features of each other's AURAs, in one embodiment of the disclosed system and method. Each session begins with users' AURAs 600 on default display backdrop 605. Mouth animation is synchronized using phonemes extracted via analysis of users' voices. Using the touch screen or a cursor 610, user's can select individual facial features to be manipulated. In the example illustrated above, the male user selects the hair of the female user. In the example shown above, color is one of the attributes of the hair that can be modified, and a touch screen color wheel 615 is presented with which the male user can modify the hair color of the female user. The female user sees the changes in her own “picture in picture” monitor. 620.

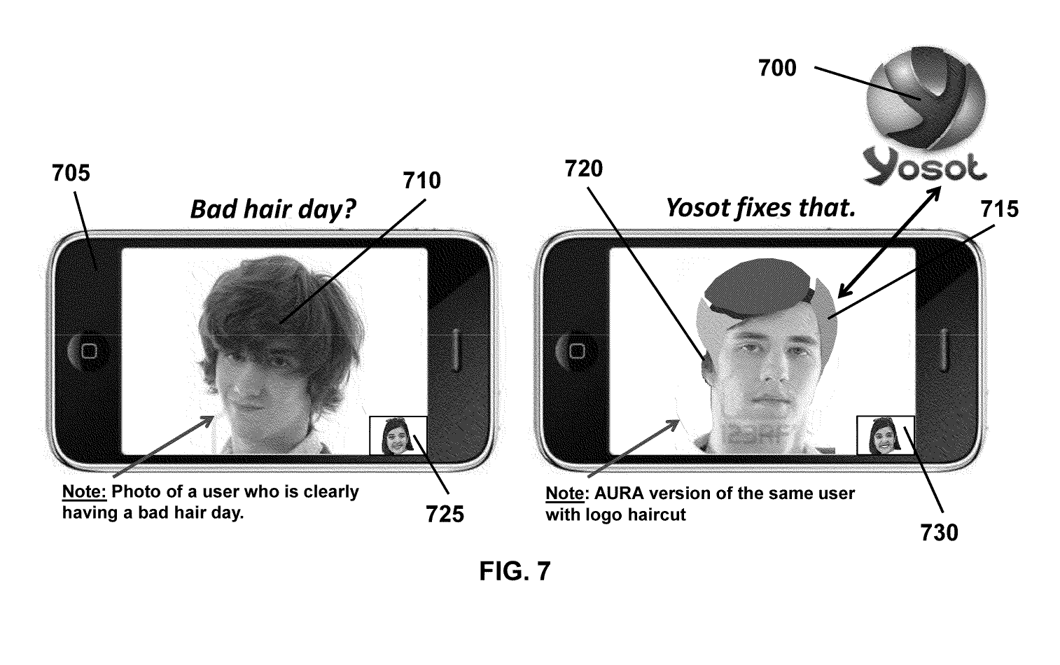

FIG. 7 illustrates an example game mode in which the BAMSGaS Client application program automatically manipulates features of a user's AURA in order to enable brand advocacy as a feature of the AURA itself, in addition to or instead of a branded display backdrop, in one embodiment of the disclosed system and method. In one embodiment the default “free” game mode, in which users become Yosot brand advocates by having a “Yosot logo haircut” 715 put on their AURAs 720. The multimedia device on the left 705 depicts a photograph of a person 710 who is having a bad hair day. The multimedia device on the right depicts a AURA version 720 of the same guy's/gal's head, not just a doctored photograph. The “picture in picture” monitor 725 depicts a photo of the chat partner, also with “bad hair.” The “picture in picture” monitor 730 depicts a AURA version of the chat partner, also with a Yosot haircut 715.

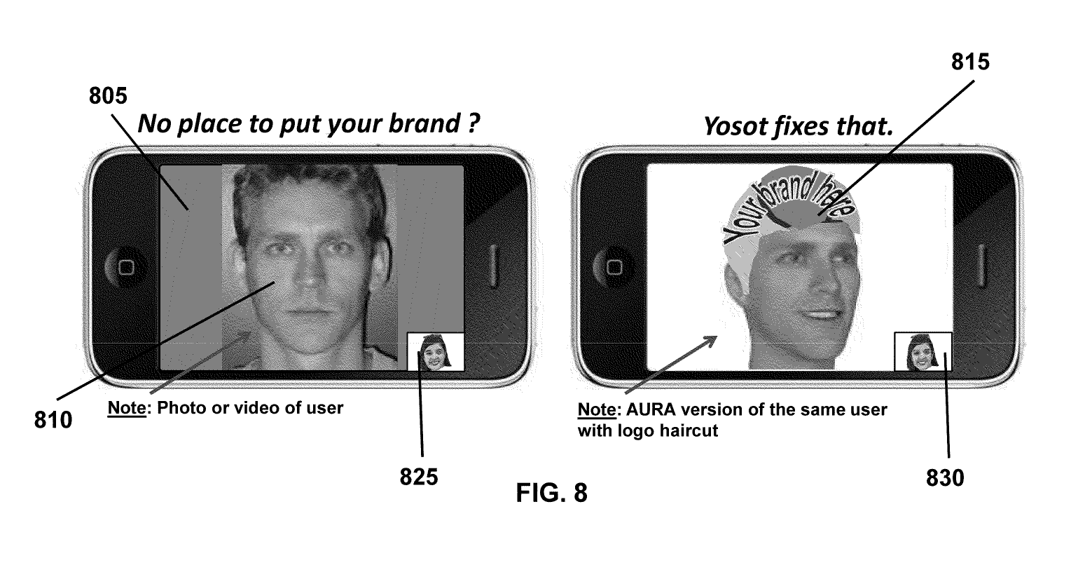

FIG. 8 shows an example of a game mode in which a user can enable brand advocacy as a feature of their AURA, in addition to or instead of a branded display backdrop, in one embodiment of the disclosed system and method. The multimedia device on the left 805 depicts a photograph of a person 810 who is having a bad hair day. The multimedia devices depicts a AURA version 820 of the same guy's/gal's head, not just a doctored photograph. The “picture in picture” monitor 825 depicts a photo of the chat partner, also with “bad hair.” The “picture in picture” monitor 830 depicts a AURA version of the chat partner, also with a Yosot haircut 815.

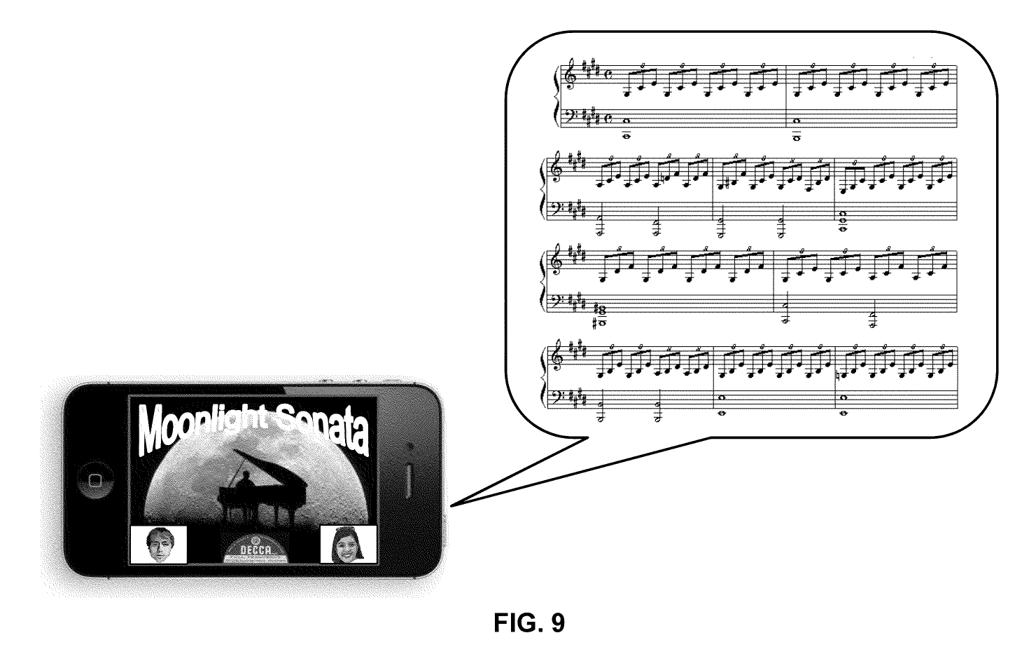

FIG. 9 shows an example of a game mode in which brand advocacy is enabled as an audio background or soundtrack, in addition to or instead of a branded display backdrop, in one embodiment of the disclosed system and method.

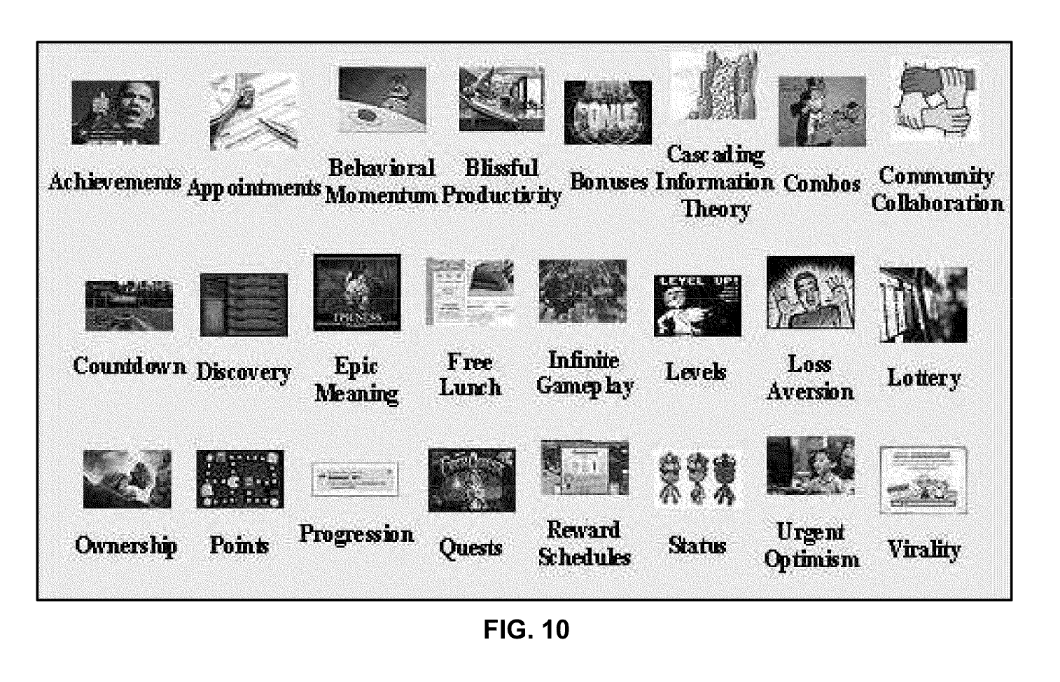

FIG. 10 shows examples of different game mechanics that can be incorporated into various embodiments of the disclosed system and method. The backdrops in Step 4 above may include, but are not limited to, a variety of static images, video clips, and animated sequences, and may also include audio or music backgrounds. These backdrops can be made available to users for free, for purchase within the application, and for download much like ringtones.

Illustrative examples of the interactive game design techniques and game mechanics in Step 5 above include, but are not limited to: discovery of objects in display backdrops that can be animated or turned into AURAs with a user's facial features; discovery of objects in display backdrops that can be animated or turned into AURAs with facial features that are animated using information derived using the user's voice; winning points for finding and animating objects in display backdrops; achieving elevated status or progressing to more advanced levels of play based on having found and animated all objects in a current display backdrop; creation and ownership of multiple unique AURAs, each of which can be or is personalized and utilized for real-time interaction with a specific group of a user's contacts.

Another embodiment of interactive game design techniques and game mechanics includes game modes that enable users to manipulate their own or each other's AURAs and display backdrops in real-time as they interact with each other. Such manipulations include, but are not limited to: Modifying the overall color palette of the AURA; morphing the overall shape and structure of the AURA, including but not limited to via system-automated morphing templates; modifying colors and shapes of specific AURA facial features including, but not limited to, eyes, nose, mouth, ears, hair, chin, cheeks; adding new features to AURAs, including but not limited to hats, glasses, earrings, ties, scarves, clothed torsos; selecting a display backdrop from within one or more collections of available display backdrops, including but not limited to a selection of available backdrop collections made available as thumbnails displayed on a user's display screen; adding, deleting, re-arranging, or modifying specific features within a display backdrop; using facial features from the user, or information derived from the user's voice, to animate objects embedded within a backdrop. Illustrative examples of animate or inanimate objects in a backdrop that may be animated in this manner include a coffee cup on a table, a clock on a wall, or a moose head hanging over a bar; and activating an audio background to be played during an interactive user session, in addition to or instead of a branded display backdrop, for example by selecting from a list of thumbnail representations of the performer, song, album, genre or other audio background selection criteria displayed on a user's display screen.

A further embodiment of the disclosed system and method includes geolocation capabilities that allow users to select local “scenic” display backdrops related to their current geographic location, where their current geographic location is determined by one or more techniques that are well known in the art.

Another embodiment of the disclosed system and method provides users with the ability to record AURA messages with display backdrops and/or audio backgrounds as described above, to send these messages to other users in non-real-time as multimedia messages, to leave such messages as multi-media “voice mails” when a real-time session cannot be established, or to use these messages as ring-tones or ring-back tones when calling or being called by specific user contacts or groups of user contacts.

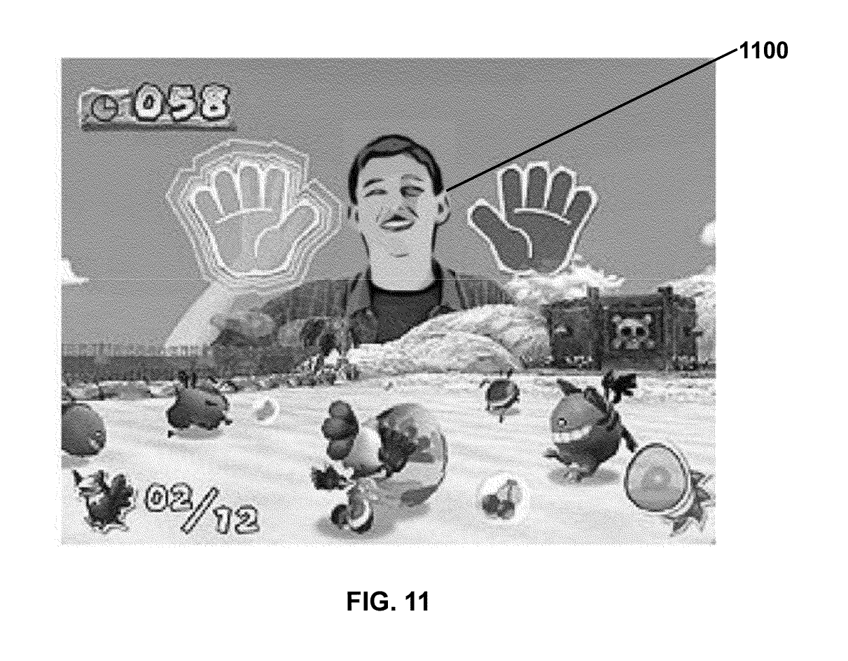

Another embodiment of the disclosed system and method provides one or more users with the ability to use their AURAs to immerse themselves as active participants in a video game that serves as the display backdrop during a real-time interaction session. FIG. 11 depicts an example of a user 1100 immersed in a video game display backdrop using their AURA, in one embodiment of the disclosed system and method.

Another embodiment of the disclosed system and method provides one or more users with the ability to use their AURAs to interact with each other in a chat or conferencing format by having their AURAs displayed in a multi-party conferencing format.

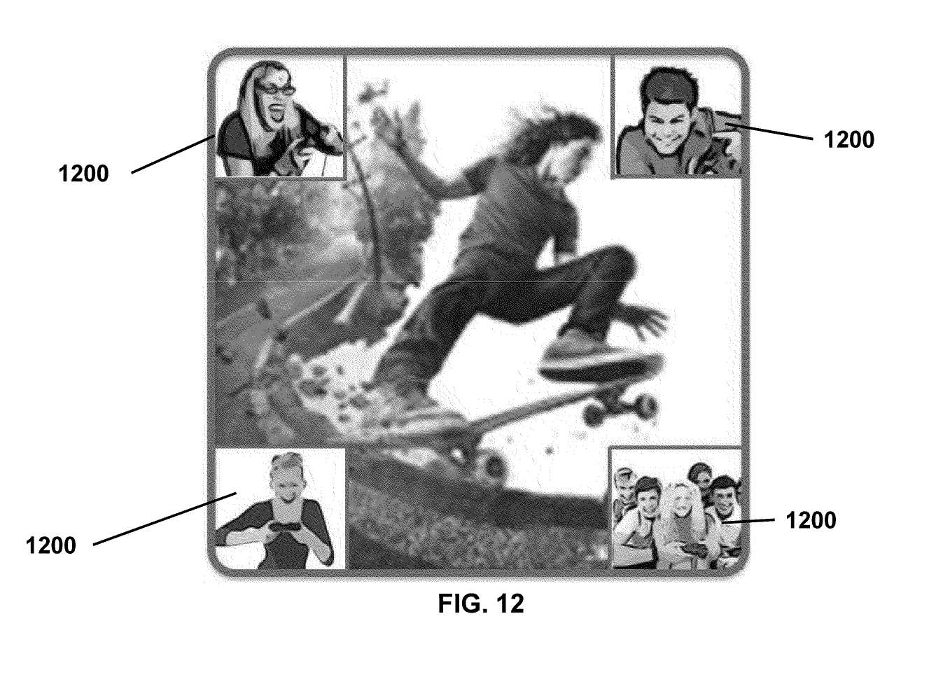

FIG. 12 depicts an example of multiple users 1200 interacting with each other by having their AURAs displayed in a multi-party conferencing format while playing a video game that serves as the display backdrop during a real-time interaction session, in one embodiment of the disclosed system and method.

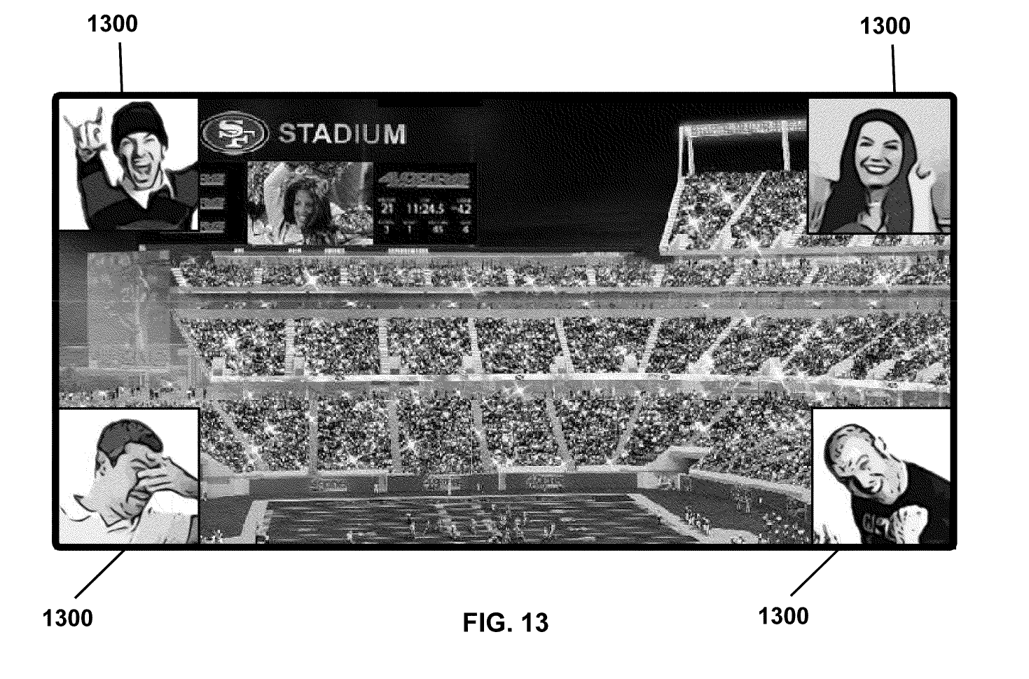

Another embodiment of the disclosed system and method provides one or more users with the ability to use their AURAs to interact with each other in a chat or conferencing format while viewing a live or recorded video broadcast program. FIG. 13 an example of multiple users interacting with each other by having their AURAs 1300 displayed while viewing a live or recorded video broadcast program 1310 that serves as the display backdrop during a real-time interaction session, in one embodiment of the disclosed system and method.

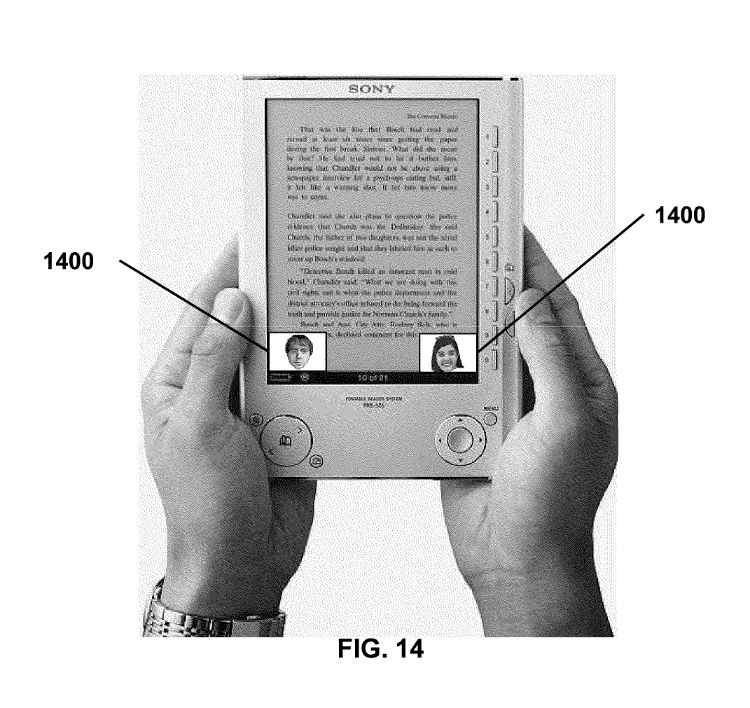

Another embodiment of the disclosed system and method provides one or more users with the ability to interact with each other using AURAs while sharing the consumption of digital media, including but not limited to electronic books, magazines, and newspapers. FIG. 14 depicts an example of users interacting with each other by having their AURAs 1400 displayed during shared reading of an electronic book. An advantage of embodiments of the disclosed system and method disclosed herein is that real-time interaction is enabled between users on devices such as electronic book readers that do not provide integrated support for real-time video interaction, but do have image and graphics storage and processing for multimedia content presentation, and network connectivity for multimedia content access and download, that are utilized in one embodiment of the present disclosed system and method to provide real-time face-to-face user interaction via AURAs.

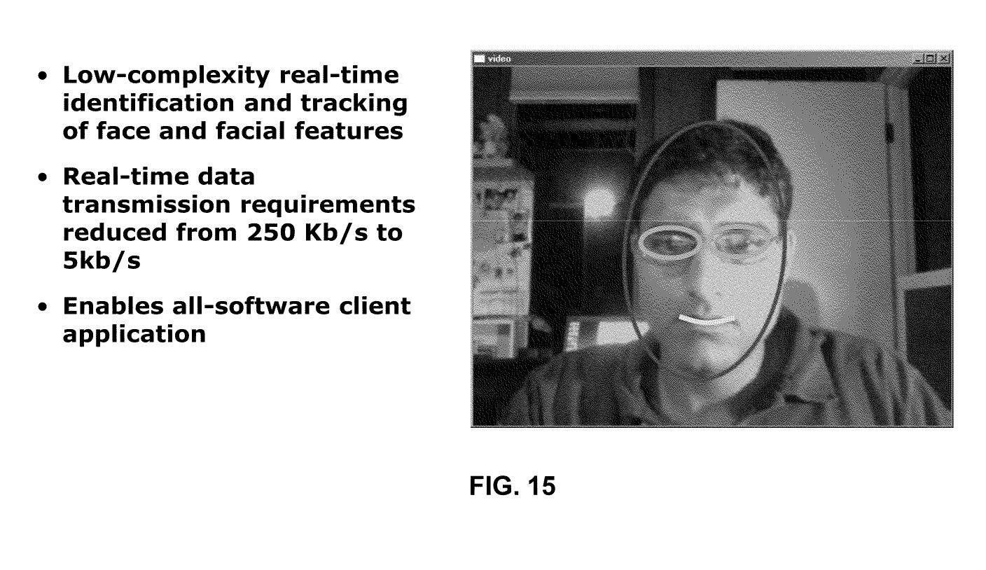

Embodiments of the disclosed system and method may provide advantages over existing mobile video chat or video conferencing services in terms of lower data rates and simpler adaptation to network fluctuations. The data rates required for real-time transmission of standard video chat with acceptable quality are on the order of 200-400 kbps (200,000-400,000 bits per second), and it is very difficult to reliably predict, detect, and compensate for mobile network delay, jitter, and packet loss. In some embodiments of the disclosed system and method, as illustrated in FIGS. 15-23, no video data at all is required to be sent between users' devices, which has the additional benefit of eliminating the computationally complex video encoding and decoding processes required for traditional real-time photo-realistic video interaction. Instead, embodiments of the disclosed system and method enable a much smaller amount of data derived from the users' facial features or voices, on the order of 10 bps-10 kbps (10-10,000 bits per second), to be sent between users' devices in order to support real-time or non-real-time animated face-to-face interaction using AURAs whose facial features are synchronized with the users' voices when displayed on the users' devices.

FIG. 15 illustrates low-computational-complexity real-time identification and tracking of a user's face and facial features, according to one embodiment of the disclosed system and method. In one embodiment of the disclosed system and method, Haar-like features are exploited as the digital image features in each photograph or video frame for face and facial feature object recognition and tracking, as shown in FIG. 15. Traditional approaches to facial recognition work with only image intensities (i.e., the Red, Green, Blue (RGB) pixel values at each and every pixel of the image), making the task of feature calculation computationally expensive. In one embodiment of the present disclosed system and method, an alternate feature set based on Haar wavelets is utilized instead of the image intensities. The resulting Haar-like feature considers adjacent rectangular regions at a specific location in a detection window, sums up the pixel intensities in these regions, and calculates the difference between them. This difference is then used to categorize subsections of an image. In the case of human faces, it is a common observation that among all faces the region of the eyes is darker than the region of the cheeks. Therefore a common Haar feature for face detection is a set of two adjacent rectangles that lie above the nose and the cheek region. The position of these rectangles is defined relative to a detection window that acts like a bounding box to the target object, which is the user's face in this case.

In the detection phase of the face detection framework, a window of the target size is moved over the input image, and for each subsection of the image the Haar-like feature is calculated. This difference is then compared to a learned threshold that separates non-objects from objects. Because such a Haar-like feature initially provides only a weak learner or classifier for feature detection, a large number of Haar-like features are necessary to describe an object with sufficient accuracy. In the present disclosed system and method, the Haar-like features are therefore organized in a classifier cascade to form a strong learner or classifier.

An advantage of the present Haar-like feature over other face detection approaches is its calculation speed. Due to the use of integral images, a Haar-like feature of any size can be calculated in constant time (approximately 60 microprocessor instructions for a 2-rectangle feature).

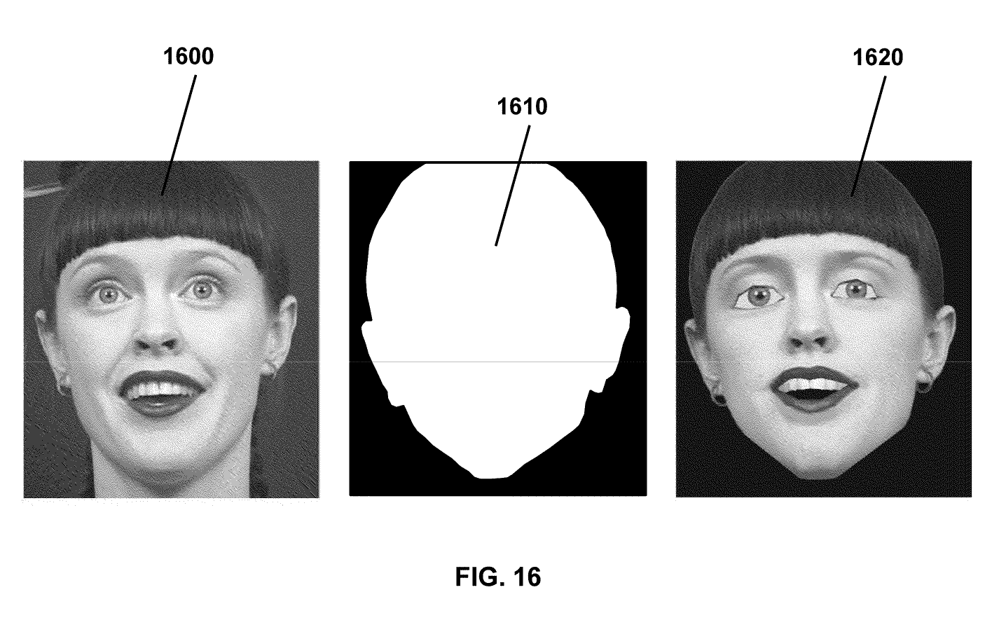

FIG. 16 illustrates the use of a mask used to determine the outline of a user's face for subsequent animation, according to one embodiment of the disclosed system and method. The left most image 1600 depicts the digital image of a person's face. The center image 1610 depicts the outline of that face. The right most image depicts the AURA 1620 for the same digital face.

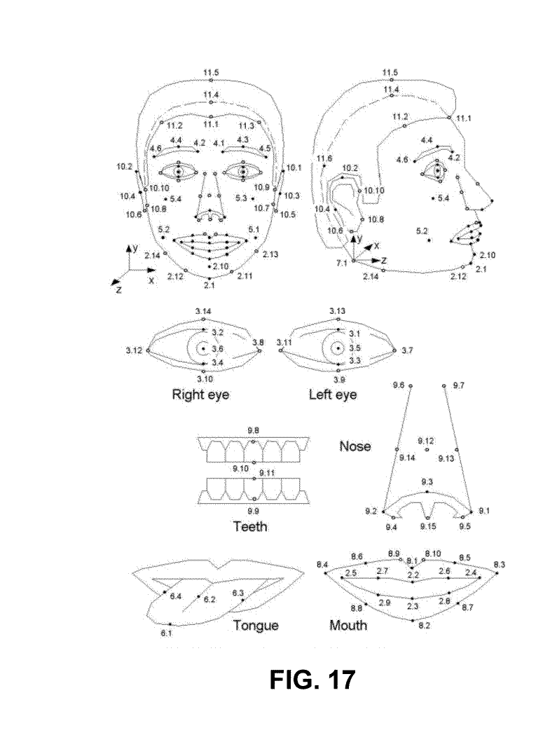

FIG. 17 illustrates identification and tracking of detailed facial features, according to one embodiment of the disclosed system and method.

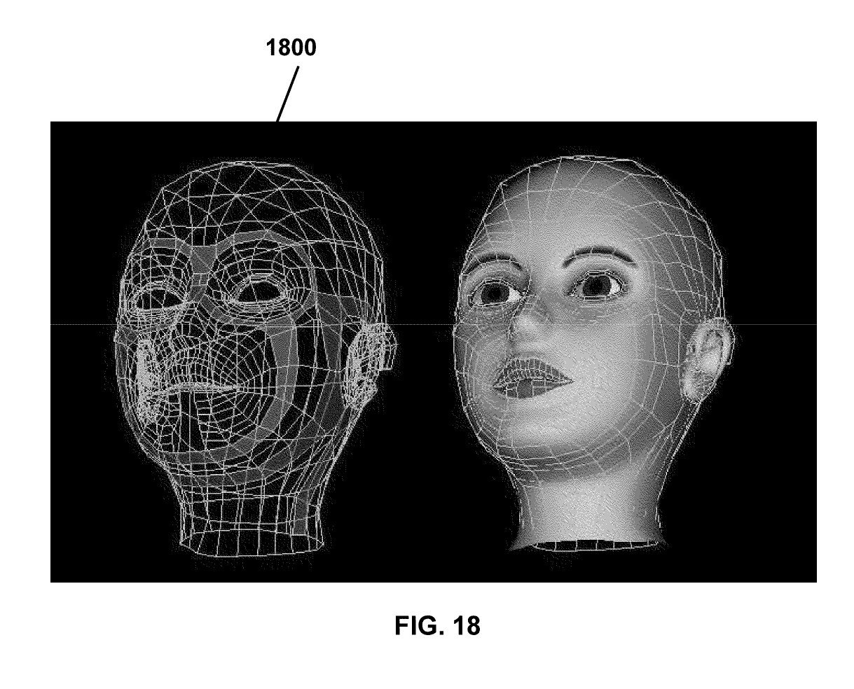

FIG. 18 illustrates the use of 3-D head mesh models 1800, according to one embodiment of the disclosed system and method.

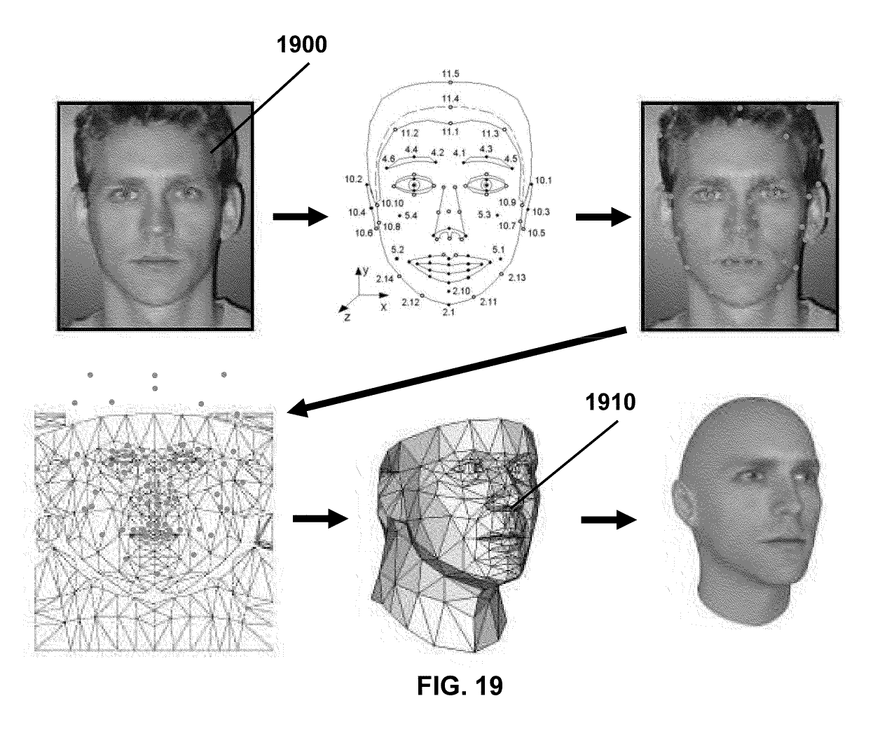

FIG. 19 illustrates placement of 2-D facial features extracted from a photograph 1900 onto a 3-D head mesh model 1910, according to one embodiment of the disclosed system and method.

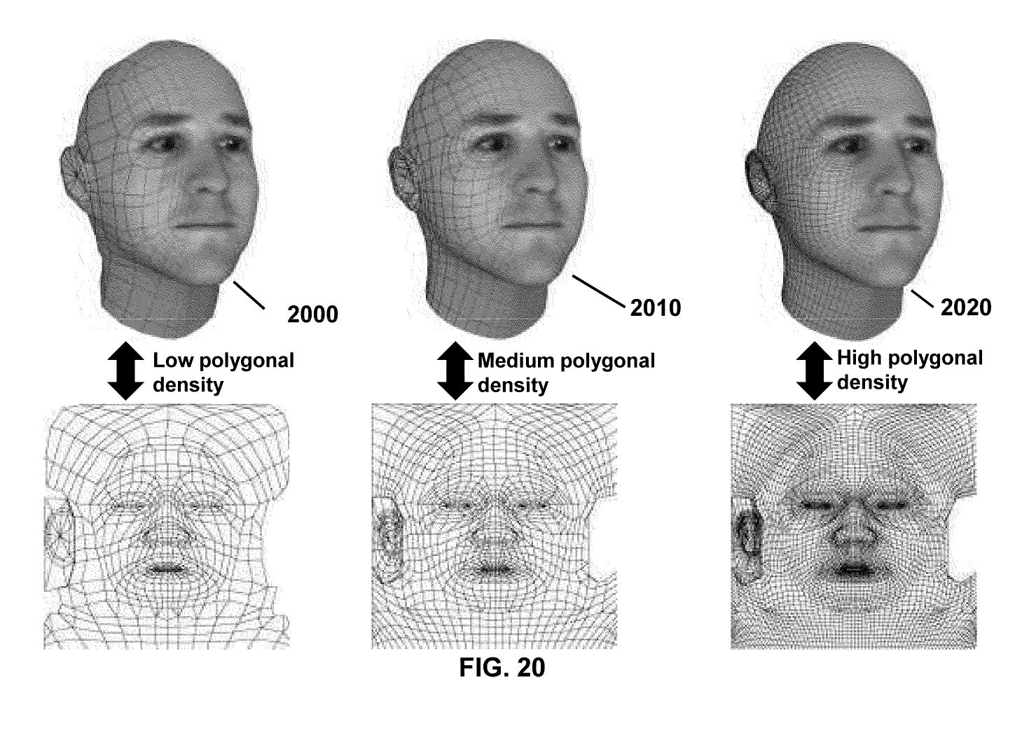

FIG. 20 illustrates 3-D head mesh models with different polygonal densities (low 2000, medium 2010, and high 2020 densities), according to one embodiment of the disclosed system and method.

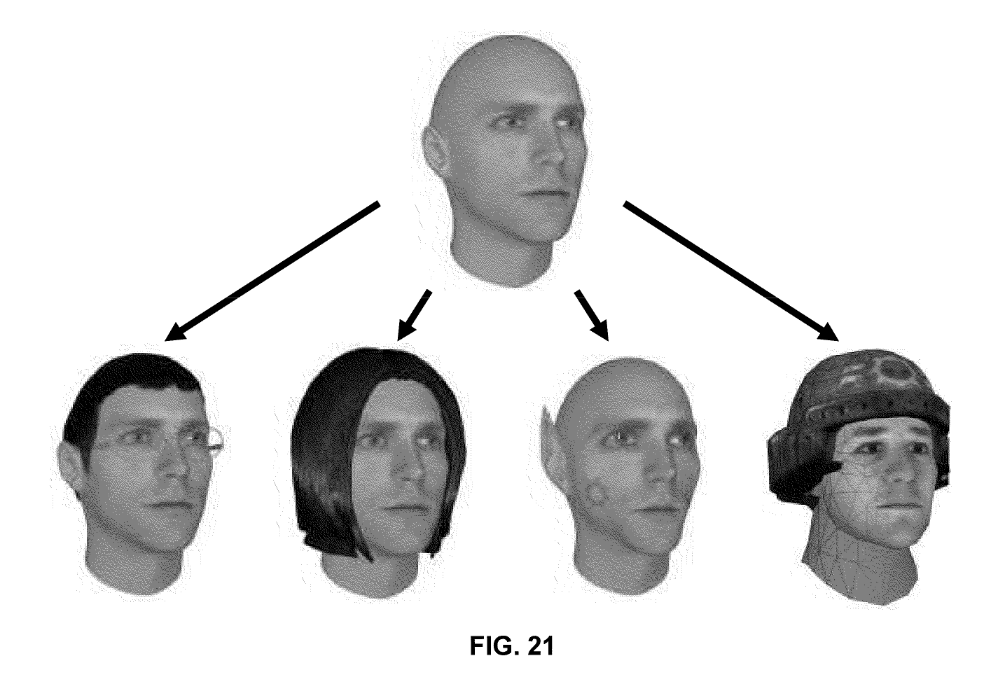

FIG. 21 illustrates modifying and adding features on AURAs, according to one embodiment of the disclosed system and method. The computational complexity of the AURA generation and manipulation process described here is minimized by: Extracting a fixed set of 2D facial features from a single photograph or from each frame of a video sequence of a user (FIGS. 15-17); Mapping the fixed set of 2D facial features onto a corresponding fixed set of features reserved on a 2D or 3D mesh model of the target AURA (FIGS. 18-19), restricting the number of mesh nodes used in the 2D or 3D mesh models for the AURA (FIG. 20). This low computational complexity enables an all-software BAMSGaS Client application that can run within the limited computational resources of mobile devices such as smart phones and tablets.

In interactive game modes where users manipulate each other's AURAs and backdrops in real-time as they talk with each other (FIGS. 6, 21), only a small amount of data (tens to thousands of bits) need intermittently be sent between the users' devices in order to enable the manipulations. At these very low bit rates, much simpler and more effective error masking can be applied during the interactive AURA session in order to compensate for mobile network delay, jitter, and packet loss, enabling delivery of a significantly enhanced user experience that can also be more effectively predicted and controlled.

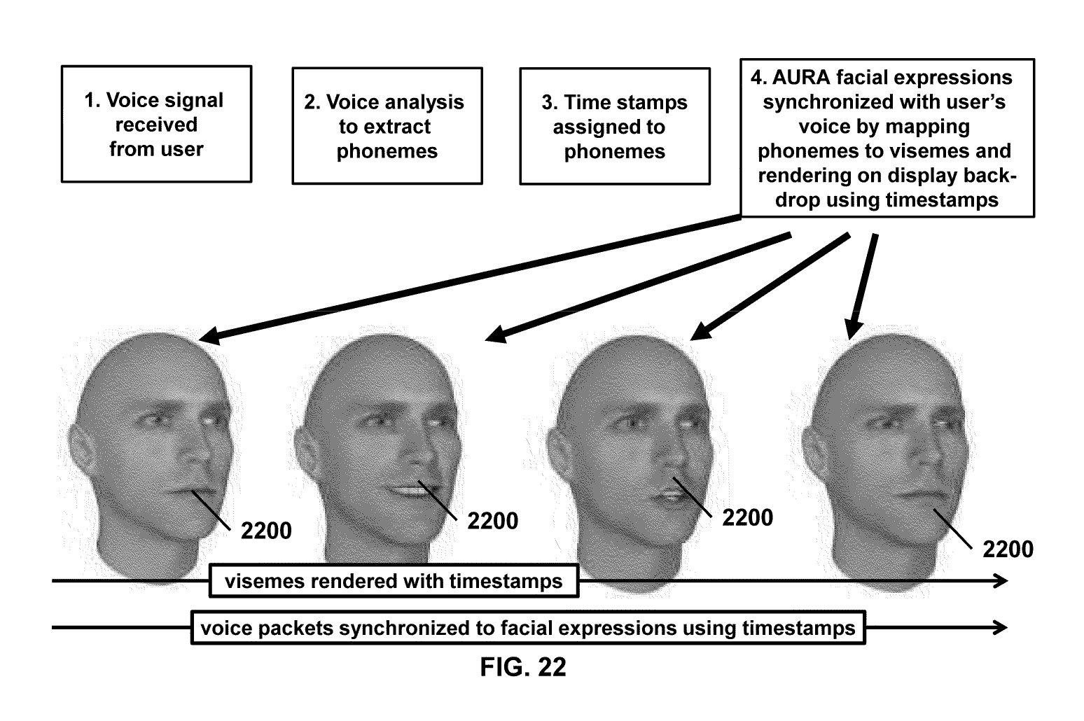

FIG. 22 illustrates animating the facial features on AURAs by synchronizing to information extracted from a user's voice, according to one embodiment of the disclosed system and method. During this process the voice signal is received from the user via a microphone. The system and method conducts voice analysis to extract phonemes. Then mouth features 2200 are mapped to phonemes (i.e. using a look up table).

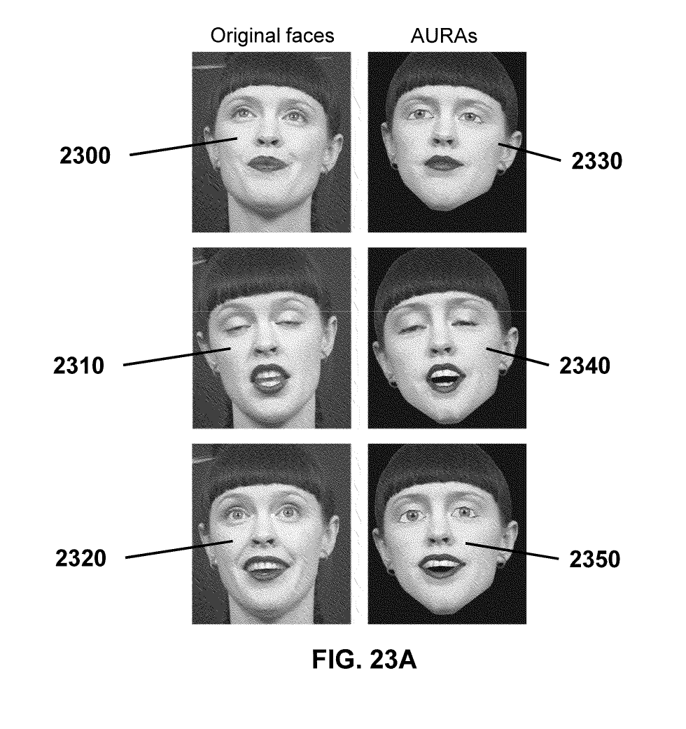

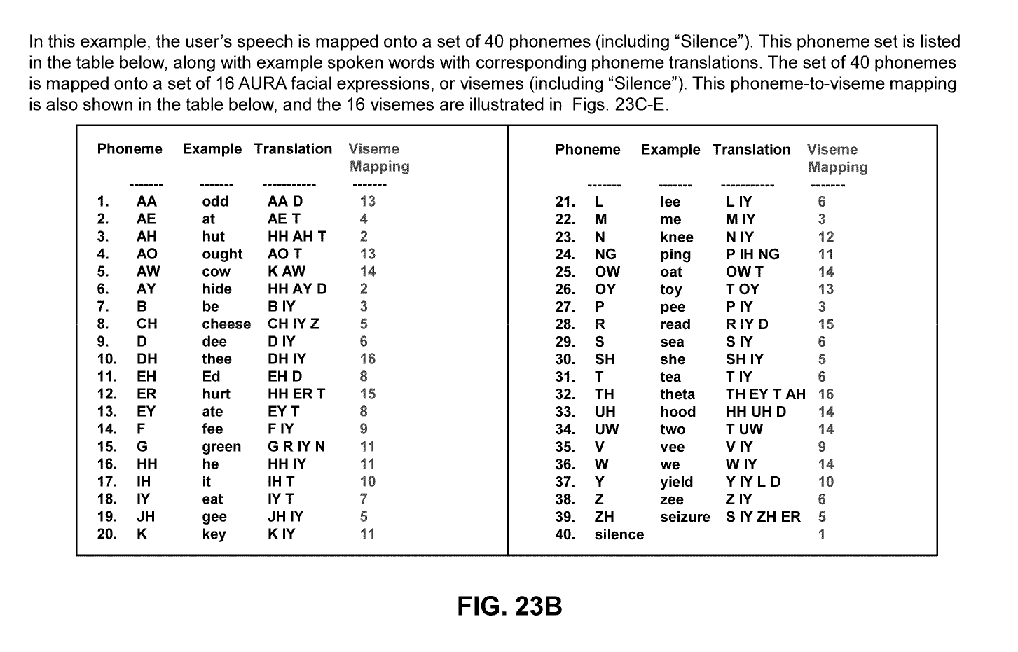

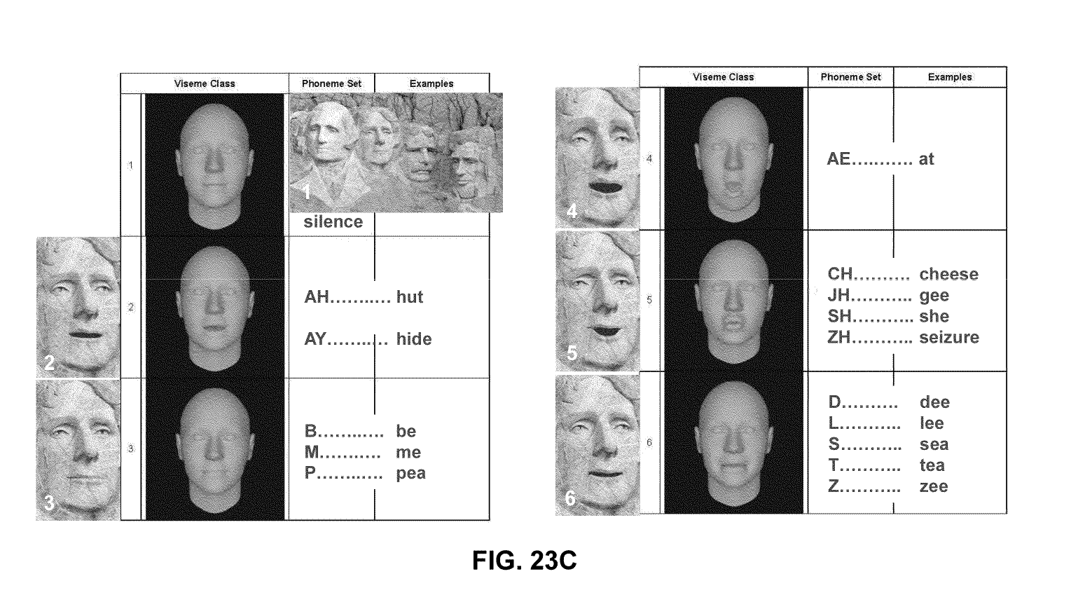

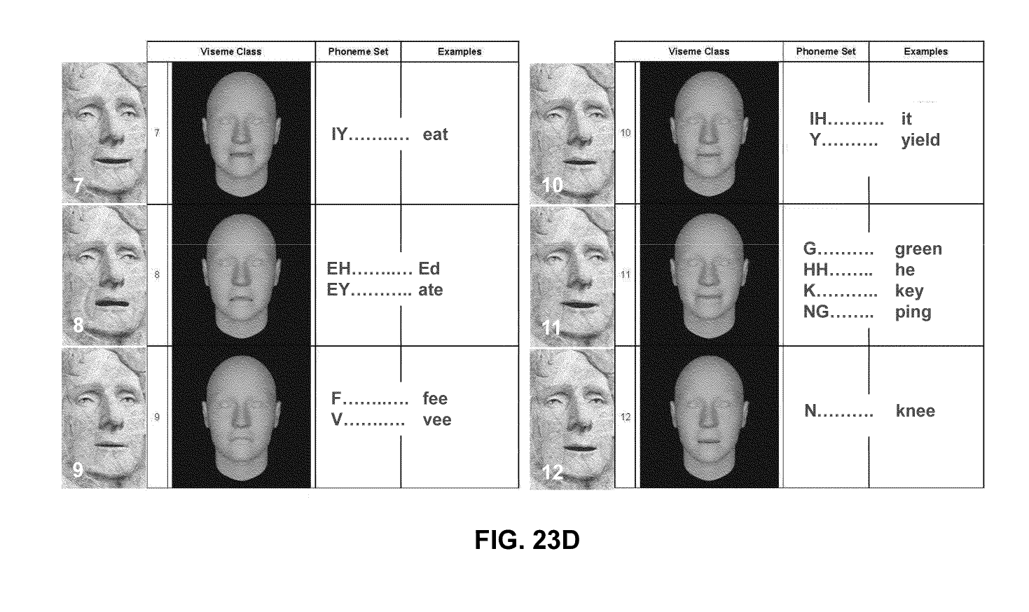

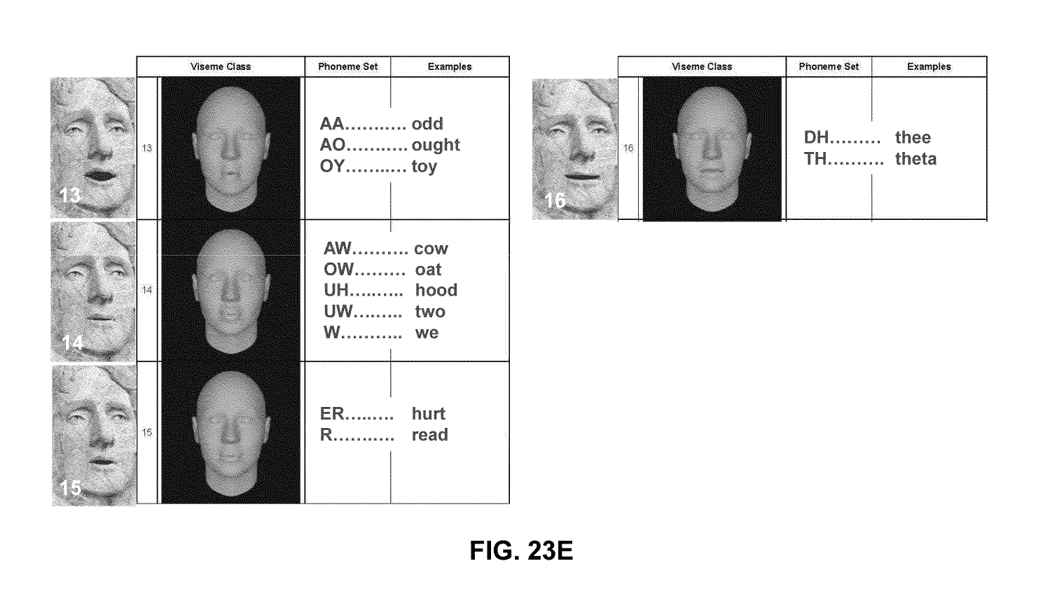

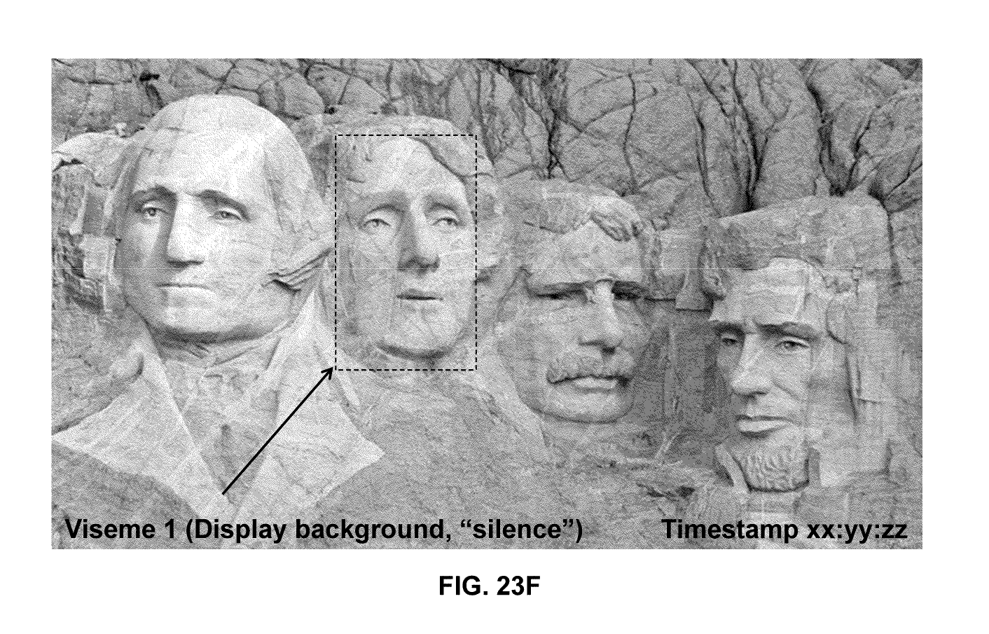

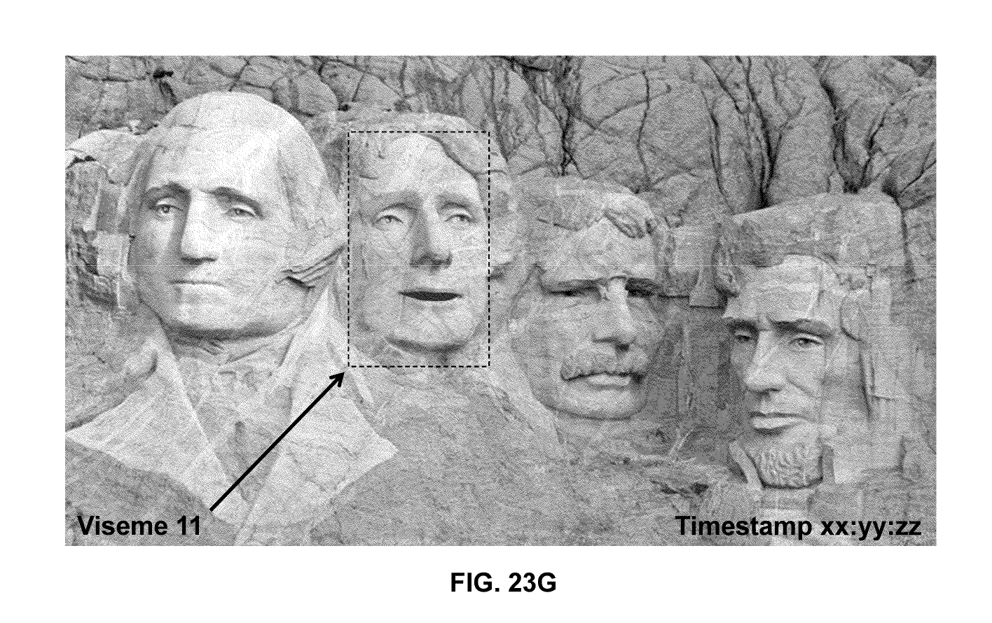

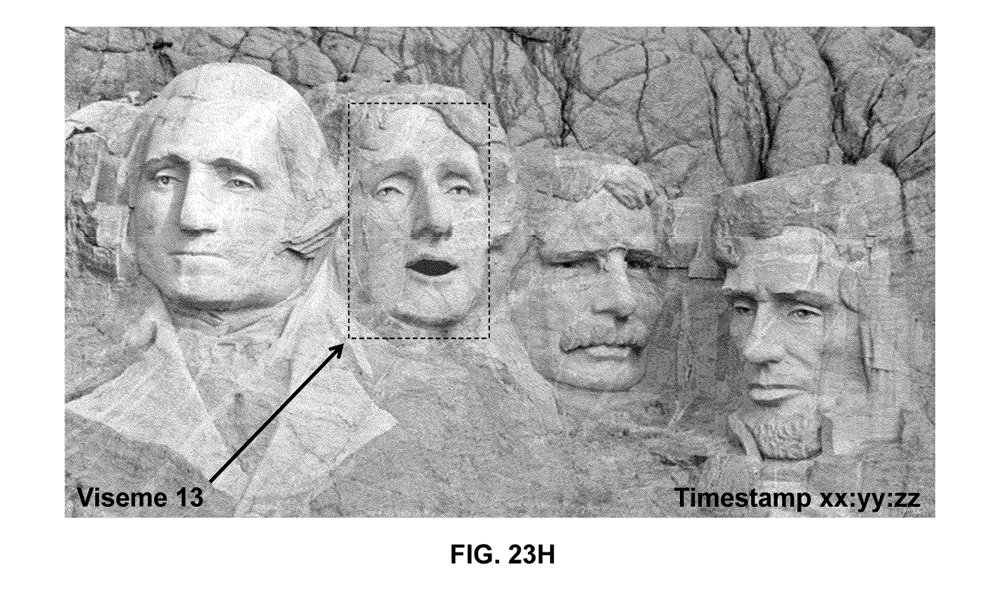

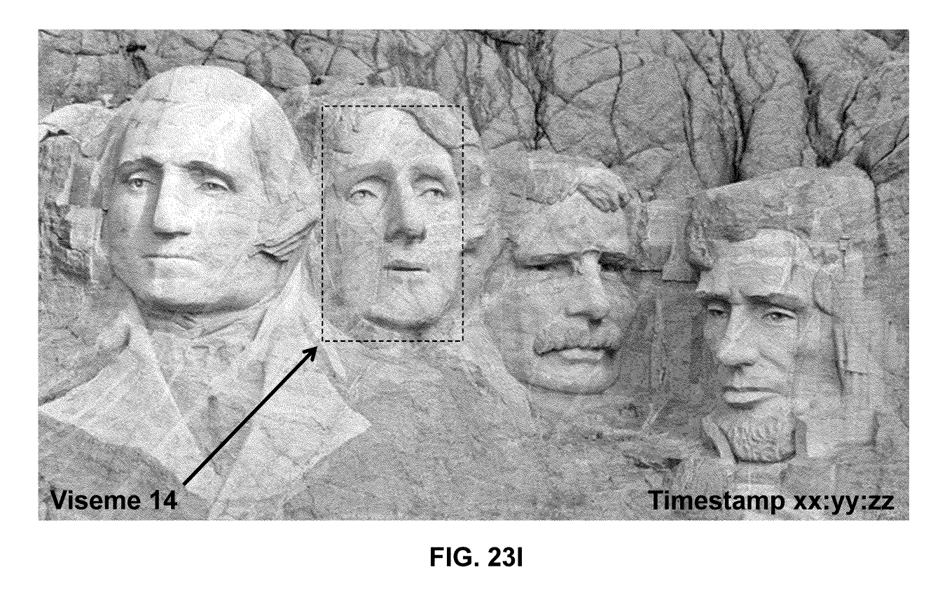

FIG. 23A illustrates examples of original faces 2300, 2310, 2320 in different frames of a video sequence, along with corresponding synchronously voice-animated AURA images 2330, 2340, 2350, suitable for real-time animated chat or non-real-time animated messaging in one embodiment of the disclosed system and method.

In both real-time animated chat sessions and non-real-time animated messaging sessions, each sending user's voice input may be analyzed in the sending user's device, in the receiving user's device, or in a networked server connected to both users' devices, in order to extract information that can then sent together with the sending user's voice signal and used to automate animation of the sending user's AURA facial expressions when it is displayed on the receiving user's device, in synchronism with the sending user's voice being played back at the same time on the receiving user's device. In one embodiment, the voice analysis may utilize one or more of several speech coding or speech processing techniques that are well known in the art to extract a fixed set of between 6 and 60 phonemes or other similar basic distinctive units of speech, as well as emotional clues or other information that can be utilized to animate the user's AURA (FIGS. 22-23).

In some embodiments of the disclosed system and method, 2D or 3D mesh models may be used to animate the AURA facial region in response to phonemes, other units of speech, emotional clues, or other information extracted from the user's voice, using techniques that are well-known in the art. In other embodiments of the disclosed system and method, 2D or 3D mesh models may be used to add simulated motion of the entire AURA head in response to phonemes, other units of speech, emotional clues, or other information extracted from the user's voice, using techniques that are well-known in the art. The use of AURAs eliminates the need for users to continuously look at their device camera in order to support face-to-face interactions, and allows each user's AURA to automatically remain centered and dimensioned relative to the display backdrop when viewed in other users' device display screens.

In other embodiments of the disclosed system and method, the computational complexity, bandwidth requirements, and network infrastructure required to support real-time animated chat and non-real-time animated messaging for user interaction and brand engagement are further reduced my mapping the fixed set of phonemes, other units of speech, emotional clues, or other information extracted from a user's voice to a fixed set of AURA facial expressions, or visemes, as illustrated in FIGS. 23B, 23C, 23D, and 23E. Analysis of the sending user's voice then generates a very low bandwidth data stream that includes only a sequence of viseme identifiers, along with corresponding time stamps relative to the sending user's voice signal, which can be transmitted to a receiving user along with the sender's voice signal. This very low bandwidth data stream can then be utilized in the receiving user's device to render any set of AURA facial expressions onto any corresponding display background in synchronism with the received voice signal, as illustrated in FIGS. 23F, 23G, and 23H. In this example, the user's speech is mapped onto a set of 40 phonemes (including “Silence”). This phoneme set is depicted in FIG. 23B, along with example spoken words with corresponding phoneme translations. The set of 40 phonemes is mapped onto a set of 16 AURA facial expressions, or visemes (including “Silence”). This phoneme-to-viseme mapping is also shown in the table in FIG. 23B, and the 16 visemes are illustrated in FIGS. 23C, 23D, and 23E.

In one embodiment of the disclosed system and method, brand advertisers may create multimedia files that each include: a display backdrop incorporating the baseline viseme (for example, “silence” for each AURA that can be selected for animation by a user, as illustrated in FIG. 23F, with pixel dimensions corresponding to the target device display screen resolution; a set of 15 additional AURA facial images corresponding to the remaining 15 visemes, three of which are illustrated in FIGS. 23G, 23H, and 23I, with each AURA facial image being labeled with the corresponding viseme identifier and the position of any one coordinate (for example, the lower left hand corner) with respect to the origin (the lower left hand corner) of the display backdrop.

In one embodiment, these multimedia files may be included with the BAMSGaS Client application when it is downloaded and installed on a user's device. In other embodiments, these multimedia files may be downloaded to a user's device when the user clicks on the brand advertisers thumbnail icon from a list displayed on the user's device, as already described herein.

Non-Real-Time Animated Messaging: In one embodiment of a non-real-time animated messaging service, the interaction between users may consist of a series of non-real-time animated message session that utilize standard data connectivity capabilities between the users' devices. An illustrative sequence of steps followed by the users may include the following:

1. User A and User B both download and install the BAMSGaS application on their devices.

2. User A selects one of two or more available AURAs embedded in a display backdrop.

3. User A hits “Record” to record their voice message. In some embodiments, each voice message may be limited to a maximum duration, for example 30 seconds, and a count-down timer may be displayed on the user's device each time they are in “Record” mode.

4. User A hits “Preview” to view their recorded message played back on their device in synchronism with their animated AURA. The BAMSGaS client application analyses user A's recorded voice data stored locally on user A's device, and extracts a fixed set of phonemes, other similar basic distinctive units of speech, as well as emotional clues or other information that is to be utilized to animate the user's AURA, and generates a data stream that includes the sequence of viseme identifiers and their corresponding time stamps as previously described herein and illustrated in FIGS. 23B through 23E. This data stream is then utilized to render the set of AURA facial expressions onto the corresponding display background in synchronism with User A's voice signal, as illustrated in FIG. 23F through 23I.

5. In some embodiments, User A's recorded voice message is first compressed and sent to a networked server. A local copy of User A's voice message is also kept on their device for the preview. The server decompresses User A's audio stream, carries out phoneme extraction, viseme mapping, and time-stamping, and sends the corresponding sequence of viseme identifiers and time stamps back to User A for playback in “Preview” mode, using the locally stored copy of their voice message and graphics libraries.

6. Following preview, User A can hit “Send” in order to have their animated message sent to User B. Alternatively, User A can hit “Record” again to record a new message.

7. In the case where voice analysis has been carried out locally on User A's device, when User A hits “Send”, an animated message consisting of User A's recorded voice signal, viseme identifier sequence, and time stamps is sent to User B. A copy of the message may also be sent to a networked server and stored for archival purposes.

8. In the case where voice analysis has been carried out on a networked server, when User A hits “Send”, the server is notified to send its copy of the voice signal, viseme identifier sequence, and time stamps to User B. A copy of the message may also be maintained on the networked server for archival purposes.

9. User B receives an alert indicating that they have received an animated message.

10. When User B hits “Play”, the message from User A is played back on their device using their locally stored graphics libraries for the AURA selected by User A, along with the copy of USER A's voice signal, viseme identifier sequence, and time stamp list received from USER A or from the server.

11. The voice message data is also stored locally on User B's device for the duration of the current session. User B can hit “Play” as many times as they want during the current session to view the locally stored animated chat message from User A.

12. User B can then hit “Record”, “Preview”, and “Send” as above to send an animated chat reply back to User A.

13. When User B hits “Record”, they can select any one of the remaining available AURAs embedded in the display backdrop, and their animated messages are played back on User A's device using User A's locally stored graphics libraries for the AURA selected by User B.

14. As the chain of messages in the above back-and-forth Conversation grows, each user can select either “Play Most Recent Message” or “Play Entire Conversation”. The server maintains all relevant state information, as well as copies of the audio files, viseme sequences, and time stamp lists for all messages in a Conversation, to deliver to the Users' devices as required.

Real-Time Animated Chat: In one embodiment of a real-time animated chat service, a real-time voice connection session is first established between the users using circuit-switched voice calling or Voice over IP (VoIP). Each user then presents an initial AURA of themselves to be displayed on the other user's display screen in order to activate real-time face-to-face chat during the same session. The presentation of AURAs may be accomplished using one of several processes, including but not limited to: Each user sending data representing their AURA to the other user's device; Data representing each user's AURA being downloaded automatically from a server to the other user's device; Data representing each user's AURA representation being retrieved automatically by the other user's device utilizing contact information already stored on the other user's device.

An illustrative sequence of steps followed by the users may include the following: 1. User A and User B both download and install the BAMSGaS application on their devices. 2. User A or User B initiates a real-time voice connection session between the users using circuit-switched voice calling or Voice over IP (VoIP). Once the session has been established, both users are presented with a selection of two or more available AURAs embedded in a display backdrop. Users may utilize a single AURA for the duration of a session, or may switch between multiple available AURAs. 3. The BAMSGaS client application analyses the local user's voice input signal and extracts a fixed set of phonemes, other similar basic distinctive units of speech, as well as emotional clues or other information that is to be utilized to animate the user's AURA, and generates a data stream that includes the local user's compressed voice signal, sequence of viseme identifiers, and their corresponding time stamps as previously described herein and illustrated in FIGS. 23B through 23E. This data stream is then transmitted to the remote user and utilized to render their locally stored set of AURA facial expressions onto the corresponding display background in synchronism with the sending user's decompressed voice signal, as illustrated in FIG. 23F through 23I. 4. In some embodiments, the sending user's compressed voice signal is routed to the remote user via a networked server. The server decompresses the sending user's audio stream, carries out phoneme extraction, viseme mapping, and time-stamping, and forwards the corresponding sequence of viseme identifiers and time stamps to the remote user to render their locally stored set of AURA facial expressions onto the corresponding display background in synchronism with the sending user's decompressed voice signal, as illustrated in FIG. 23F through 23I. 5. Copies of the complete real-time chat session may also be maintained on the networked server for archival purposes. The server maintains all relevant state information, as well as copies of the audio files, viseme sequences, and time stamp lists for all archived messages, to deliver to the Users' devices as required.

In various embodiments of both real-time chat and non-real-time messaging, the voice analysis and AURA animation process disclosed herein may be used to identify and remove/mask sequences of phonemes or other units of speech that correspond to expletives and other words that users or advertisers do not wish to have transmitted during a session. This capability of the BAMSGaS system enables very effective deployment of user interaction and brand engagement services that are, for example, child-safe and brand safe.

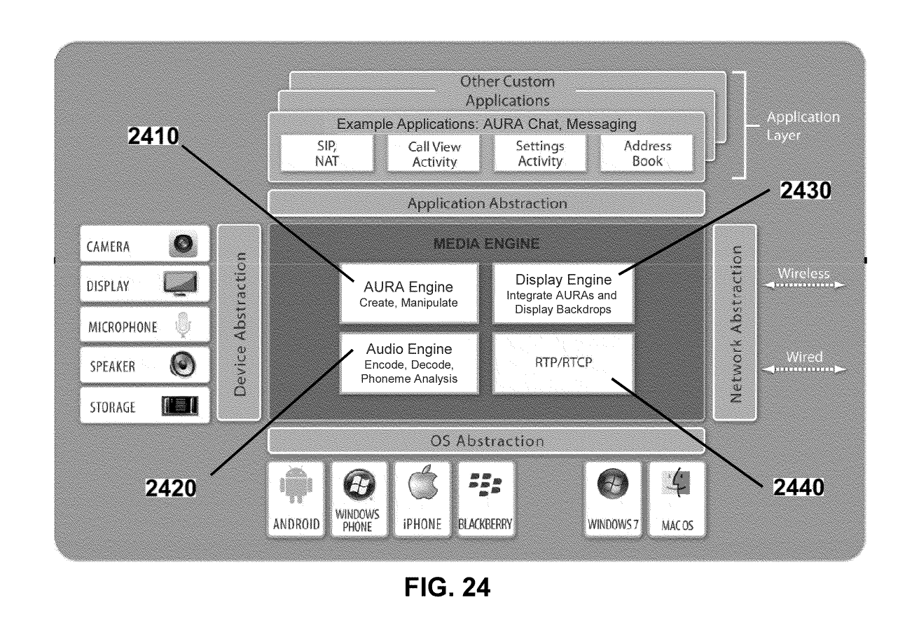

BAMSGaS Client Application Program: FIG. 24 presents a block diagram illustrating one embodiment of the BAMSGaS Client application according to the disclosed system and method. As illustrated in FIG. 24, the BAMSGaS Client integrates all of the following functions into a single all-software application compatible with leading smartphone, tablet, PC, and embedded device operating systems: AURA creation and manipulation functions 2410; audio encode, decode, and phoneme analysis functions 2420; audio/AURA synchronization functions; display integration of AURAs, display backdrops, and other multimedia content 2430; and network signaling, transport, and control protocols 2440.

The highly modular and open API architecture of the BAMSGaS Client supports rapid and flexible device and service customization. Key components of the BAMSGaS Client application include: Application Layer; Media Engine; and Device Abstraction, OS Abstraction, and Network Abstraction modules.

The Application Layer provides the primary user interface (UI), and can be rapidly customized to support a wide range of real-time interaction applications and services with specific User Experience Design (U×D) requirements. In one embodiment of the disclosed system and method, the Application Layer is implemented in Java to leverage the many additional capabilities included in today's mobile device, PC, and embedded device platforms. An example Application Layer for a mobile real-time animated chat service would include the following modules:

| | |
|---|---|
| SIP, NAT | Ensures compatibility with real-time communications infrastructure deployed by |
| (Session Control) | mobile operators and Internet service providers. Implements SIP-based call |
| Module | session provisioning, device registration, device and service capabilities |
| | exchange, call session management, and media routing. The Client can |
| | interoperate with multiple SIP servers and other proprietary signaling protocol |
| | servers. |
| Call View | Implements the User Interface (UI) for each application, allowing for |
| Activities Module | customer-specific branding at both the device and service level. |
| Settings Module | Governs the user editable settings for each application or service. Settings are |
| | preserved in the device database and thus persistent. |
| Address Book | Interacts with both the native handset address book and any additional Network |
| Module | Address Book and Presence functions. |

The Media Engine implements all media (image, graphics, AURAs, video and audio) processing and delivery functions. The Media Engine collects media streams from their designated sources; encodes, decodes, analyses, and processes them as required; and delivers the encoded/decoded/processed media streams to their designated destinations. Each media source may be a hardware device (camera, microphone), a network socket, or a file. Similarly, each media destination may be a hardware device (display, speaker), a network socket, or a file.

The RTP/RTCP stack in the Media Engine enables efficient network operations, and interfaces directly with input devices (camera, display) and output devices (microphone, speaker) via a hardware abstraction layer.

Audio codec functions are also fully abstracted in the Media Engine, so that the BAMSGaS Client can be configured to utilize a wide range of embedded or add-on audio codecs, acoustic echo cancellation solutions, and other audio analysis and processing functions.

The Media Engine communicates with the Application layer thru a well-defined Application Programming Interface (ME-API) for rapid and flexible customization across a wide range of real-time and non-real-time interaction applications. The ME-API also enables a “headless” client, allowing third parties to develop their own custom applications.

The Device Abstraction, OS Abstraction, and Network Abstraction modules allow installation and interoperability of the BAMSGaS Client on devices running all of today's leading smartphone, PC, and embedded operating systems. They also allow the BAMSGaS Client to accommodate the wide range of cameras, displays, and audio hardware found in smartphones, tablets, PCs, and other devices, and allow real-time interaction services to leverage the widest possible range of 3G, 4G, WiFi, DSL, broadband, and other wireless or wireline network connectivity modes.

Brand-Supported Display Backdrops, AURAs, and Other Multimedia Content. As illustrated in FIGS. 3-9, embodiments of the disclosed system and method enable new methods of interaction between mobile subscribers and engagement with advertisers/content providers, beyond the limits imposed by traditional Internet advertising paradigms.

Embodiments of the disclosed system and method provide mobile Internet advertisers/content providers with new tools to target their products and services to specific groups of consumers and receive prompt feedback as to the effectiveness of their advertising campaigns.

Embodiments of the disclosed system and method allow an advertiser/content provider to develop and submit their own display backdrops, AURAs, and other multimedia content, according to well defined design guidelines.

Embodiments of the disclosed system and method provide an on-line marketplace where companies selling products, services, or information bid in an open auction environment to influence the prominence of a thumbnail or other representation of their display backdrop, AURA, and other multimedia content offerings in a list presented to users during a real-time or non-real-time interaction session.

Embodiments of the disclosed system and method give advertisers/content providers the ability to bid on the duration for which their display backdrop remains on a user's screen during a real-time interaction session or non-real-time message session. Bidding may be based on target user demographics provided by advertisers/content providers. Advertisers/content providers may be given options to bid for specific incremental durations, for example in increments of 15 seconds or 30 seconds, to bid for minimum and/or maximum display durations, or to bid for the entire duration of the real-time interaction session or non-real-time message session.

The openness of this advertising marketplace can be further facilitated by publicly displaying, to consumers and other advertisers/content providers, the price bid by an advertiser/content provider for a particular display backdrop placement. Embodiments of the disclosed system and method therefore provide systems and methods for enabling advertisers to influence the prominence on a list of available backdrops or the duration of a backdrop's display for a specified set of target user demographics.

Embodiments of the disclosed system and method provide a system and method for enabling advertisers/content providers to specify key user demographics so as to target their display backdrop and AURA insertions at audiences most relevant to their products and services.

Embodiments of the disclosed system and method provide a system and method for enabling advertisers/content providers to monitor, examine, and analyze their current display backdrop and AURA insertions online and to make substantially instantaneous changes to the display backdrops, AURAs, and other multimedia content that they wish to offer and their related backdrop placement criteria.

Embodiments of the disclosed system and method provide a system and method for enabling advertisers/content providers to influence a higher prominence on list of available backdrops or a longer duration of backdrop display via a continuous, competitive online bidding process.

Embodiments of the disclosed system and method provide a cost-effective method of mobile Internet advertising where the advertiser/content provider is charged in direct proportion to the number of times their backdrop is selected and the cumulative duration of each backdrop's utilization by mobile subscribers.

Embodiments of the disclosed system and method create a new system of mobile Internet advertising where advertisers/content providers interactively engage the most interested consumers by offering in-app purchases of: real-goods displayed within a backdrop; virtual brand-related goods to enhance, customize, or personalize a display backdrop or AURA; premium backdrop content, including but not limited to commercial images, video, games, and audio soundtracks.

Embodiments of the disclosed system and method create an open market for mobile Internet advertising that is fair to consumers and advertisers/content providers, where advertiser-placed backdrops displayed during real-time animated chat sessions or non-real-time message sessions clearly labeled as paid advertising.

Embodiments of the disclosed system and method prevent abuse by implementing automated systems to guard against abusive display backdrop submission and distribution, or abusive bidding by competitors or corrupt web developers.

NETWORK CONNECTIVITY INFRASTRUCTURE PLATFORM: Embodiments of the disclosed system and method enable high-quality, real-time or non-real-time interactive mobile communications application and service with animation, game mechanics, and integrated brand advertising to be deployed using standard, low-cost, cloud-based infrastructure and connectivity, eliminating the cost and complexity associated with dedicated networks and infrastructure.

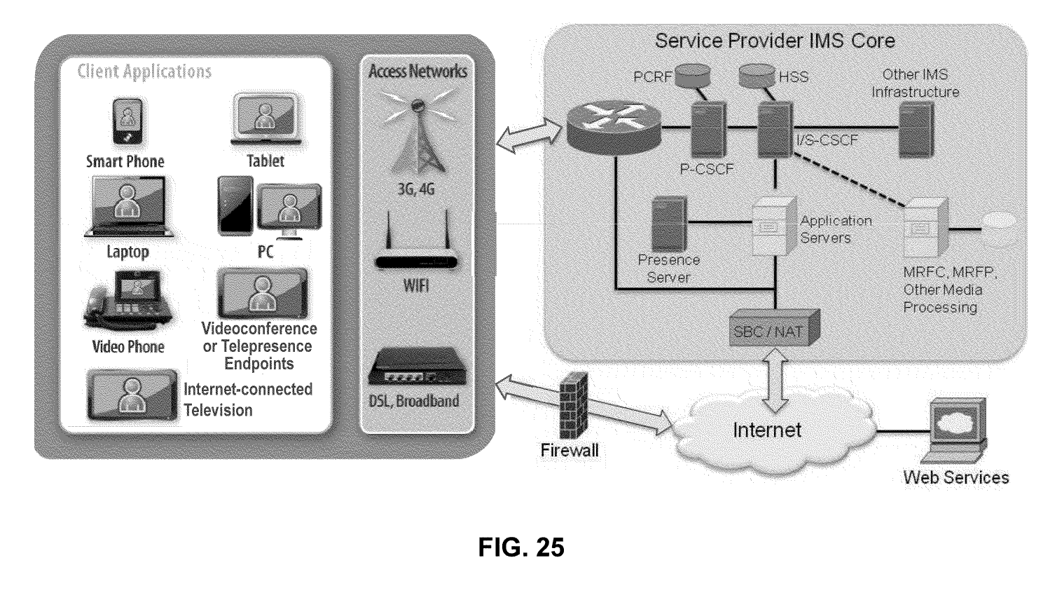

FIG. 25 presents a block diagram illustrating one embodiment of a network connectivity infrastructure platform consistent with the disclosed system and method. In order to meet user expectations for high quality real-time chat and non-real-time messaging interactions across a wide range of devices and networks, mobile operators and other communication service providers worldwide have made significant new investments in IP Multimedia Subsystem (IMS) network infrastructure. By reducing bandwidth consumption and supporting higher concurrent user loading capacities for a given infrastructure investment and bandwidth allotment in an IMS deployment, as shown in FIG. 25, the current disclosed system and method provides significant capital expense (CapEx) and operational expense (OpEx) reductions compared to alternative approaches to face-to-face interaction that utilize significantly higher video bandwidths and require additional specialized video hardware in both the user devices and the network infrastructure.

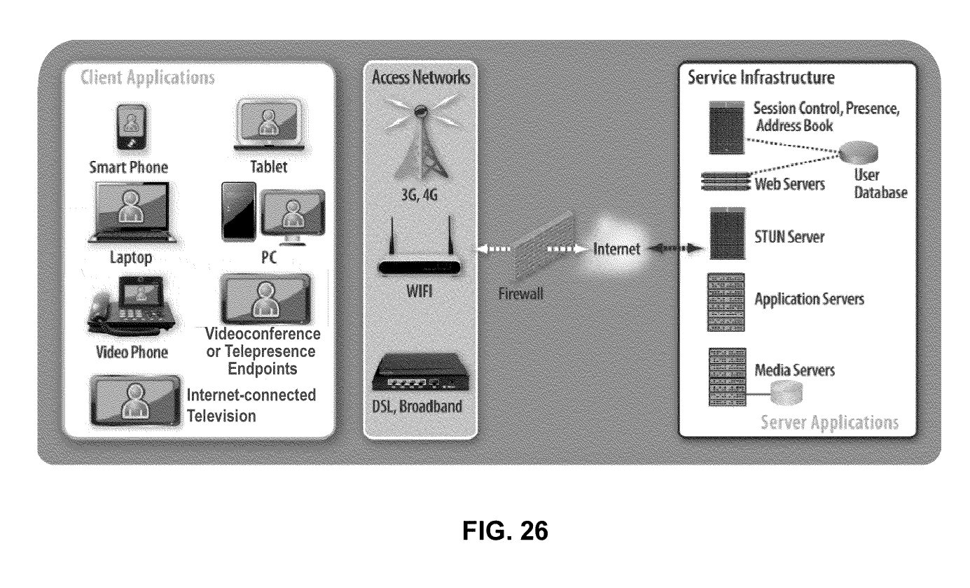

Embodiments of the disclosed system and method also deliver similar CapEx and OpEx benefits for “over the top” (OTT) and direct-to-subscriber deployments of network connectivity infrastructure platforms, one embodiment of which is shown in FIG. 26 using standard utility server hardware in a cloud computing infrastructure. In this case, mobile devices communicating via public Internet or corporate networking infrastructure typically do not have access to the same quality-of-service (QoS) enhancements found in a mobile operator's IMS core. The low data bandwidth utilization features of the BAMSGaS application and service disclosed here then become critical to delivering compelling user interaction and brand engagement experiences within the real-world constraints of mobile networks and consumer Internet connections.

ACCOUNT MANAGEMENT AND BIDDING PLATFORM FOR ADVERTISERS AND OTHER CONTENT PROVIDERS: By making each user's choice of branded display backdrop, AURA, and other multimedia content available to advertisers and other content providers as a platform for presenting and delivering ads and other content in a variety of different multimedia formats, both static and interactive, the present disclosed system and method provides advertisers and other content providers with a level of control, targetability, interactivity, and measurability not generally available in other real-time mobile communications, gaming, and advertising applications and services. Furthermore, by allowing individual users to select the brand-supported backdrops, AURAs, and other multimedia content that will be viewed by others with whom they participate in real-time chat or non-real-time messaging interaction sessions, the present disclosed system and method provides advertisers and other content providers with systems and methods that convert users into brand advocates in a manner that is more direct, immediate, and effective than other real-time mobile communications, gaming, and advertising applications and services.

Embodiments of the disclosed system and method may include tools with which advertisers and other content providers have the ability to target their products and services to specific groups of consumers and receive prompt feedback as to the effectiveness of their advertising and content distribution campaigns. These tools further enable advertisers and other content providers to control the design and placement, and bid to enhance the prominence, of their display backdrop offerings in one or more list formats presented to users on their device displays, facilitating an on-line platform that provides consumers with quick and easy access to a wide variety of brand-supported display backdrops, AURAs, and other multimedia content, and at the same time provides advertisers/content providers with a cost-effective way to target specific groups of consumers based on a variety of metrics or criteria, and to convert these users into brand advocates.

In an on-line Pay-for-Prominence platform disclosed here, advertisers and other content providers bid in an open auction environment to more prominently position thumbnail representations, or representations in other formats, of their logos or display backdrop and AURA offerings in a list displayed on each targeted user's device during a real-time or non-real-time interaction session. Advertisers/content providers have an incentive to bid on more prominent placement of their display backdrop offerings on the devices of those users whose profiles are most relevant to the advertiser's/content provider's product or service offerings, according to some metric or combination of metrics. The more prominent an advertiser's/content provider's presentation in a list displayed on a user's device, the higher will be the likelihood of the user selecting that backdrop and AURA to be viewed by those other users with whom they are engaged in an interaction session; that is, the higher the likelihood that a consumer will be recommending or advocating an advertiser's/content provider's products or services to friends and colleagues with whom they interact.

In various embodiments of the disclosed system and method, the user metrics or criteria utilized by advertisers/content providers to determine the target level of prominence to bid for a thumbnail representation, or representation in another format, of a logo or display backdrop offering may include, but are not limited to, the following: User's age; User's gender; User's area code, zip code; User's state, country of residence; User's geolocation; User's mobile carrier; User's handset model; User's handset operating system; User's credit score; User's ethnicity; User's nationality; Products or services know to have been purchased by user; Other demographic criteria; and Other contextual criteria.

In various embodiments of the disclosed system and method, advertisers/content providers may also utilize user-independent metrics to determine the target level of prominence to bid for a thumbnail representation, or representation in another format, of their user engagement offerings, including, but not limited to: time of day; temporal proximity to specific holidays or other retail seasons (back to school, Halloween Valentine's Day, Mothers' Day, Fathers' Day, etc.) Embodiments of the disclosed system and method therefore provide systems and methods for enabling advertisers and other content providers to influence the prominence of their user engagement offerings in lists of thumbnails seen by a specified set of targeted users engaged in real-time or non-real-time interaction.

Methods and systems for generating a pay-for-prominence result determined by a product or service promoter, such as an advertiser or other content provider, over a client/server based computer network system are disclosed. The following description is presented to enable any person skilled in the art to make and use the disclosed system and method. For purposes of explanation, specific nomenclature is set forth to provide a thorough understanding of the disclosed system and method. Descriptions of specific applications are provided only as examples. Various modifications to the preferred embodiments will be readily apparent to those skilled in the art, and the general principles defined herein may be applied to other embodiments and applications without departing from the spirit and scope of the disclosed system and method. Thus, the disclosed system and method is not intended to be limited to the embodiments shown, but is to be accorded the widest scope consistent with the principles and features disclosed herein.

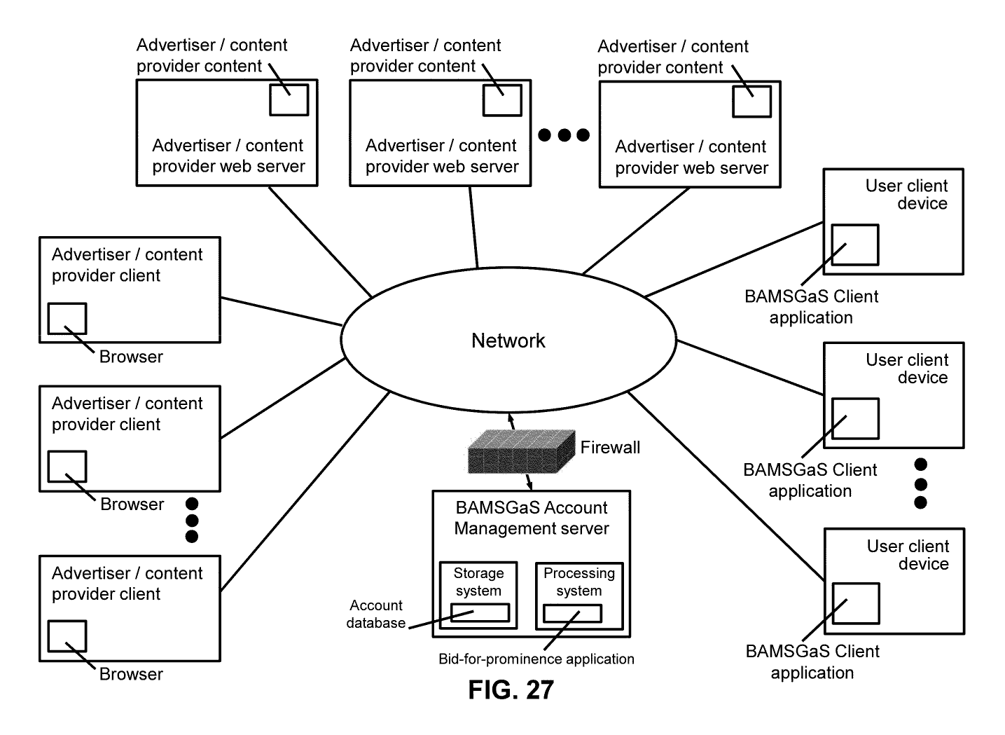

FIG. 27 is a block diagram illustrating the relationship between a large network and one embodiment of a system and method for generating a pay-for-prominence result in the disclosed system and method.

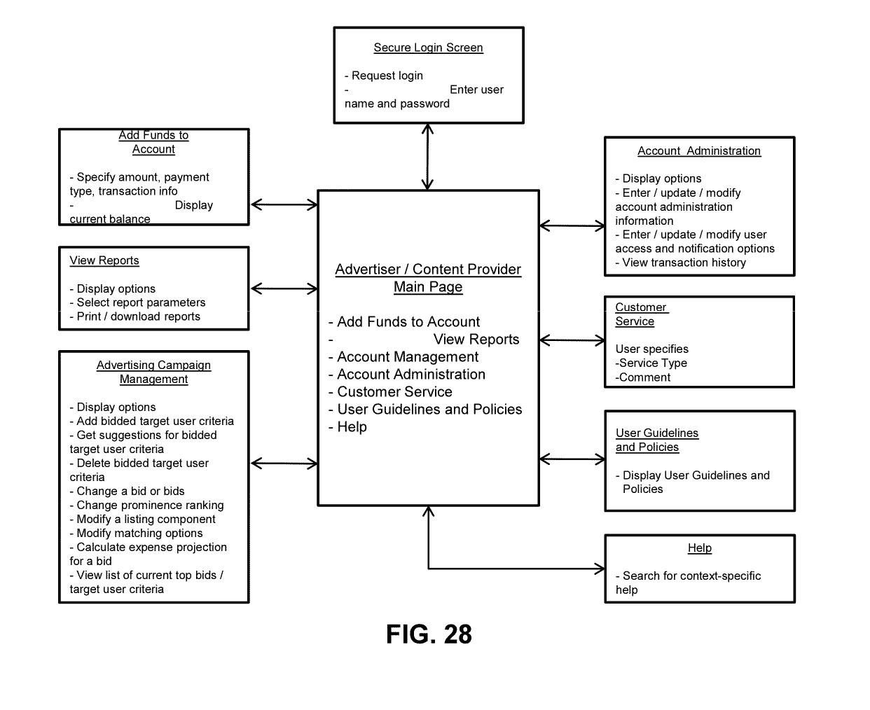

FIG. 28 is a chart of menus, display screens, and input screens used by advertisers who bid for a Pay-for-Prominence result in one embodiment of the disclosed system and method.

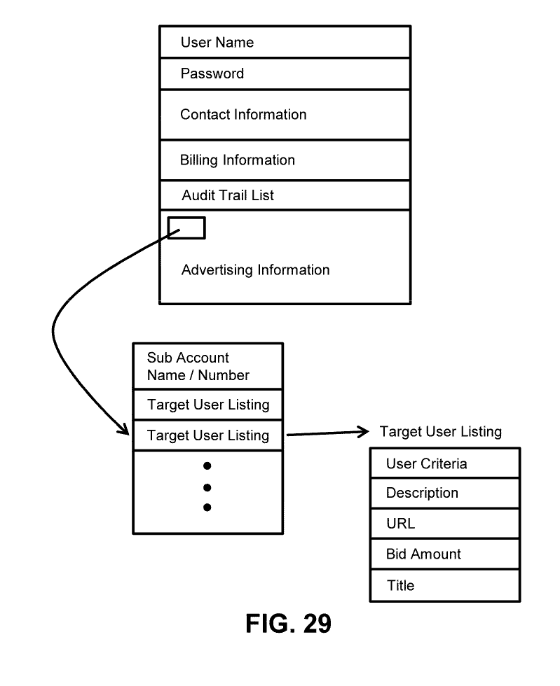

FIG. 29 is a diagram showing data in an advertiser's account record for use with one embodiment of the disclosed system and method.

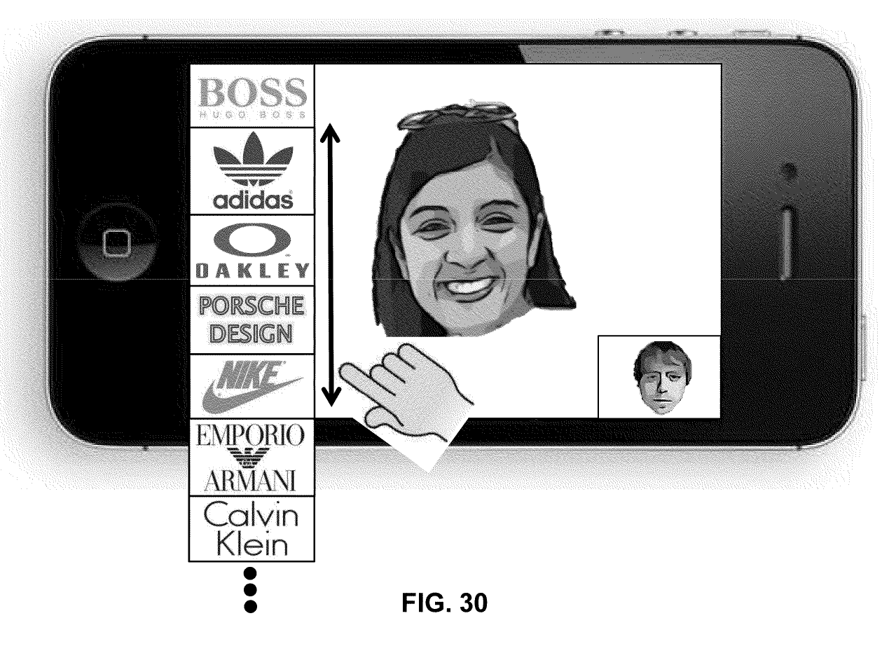

FIG. 30 illustrates an example of a scrollable Pay-for-Prominence thumbnail list display result generated in one embodiment of the disclosed system and method.

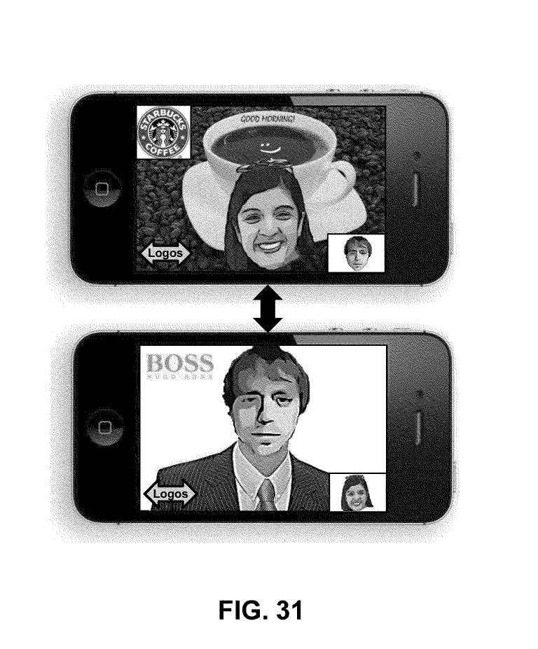

FIG. 31 shows an example click-through result of users in a real-time interactive session having clicked on brand logos displayed as bid result list entries on their mobile devices in order to retrieve and display the corresponding branded display backdrop and AURA.

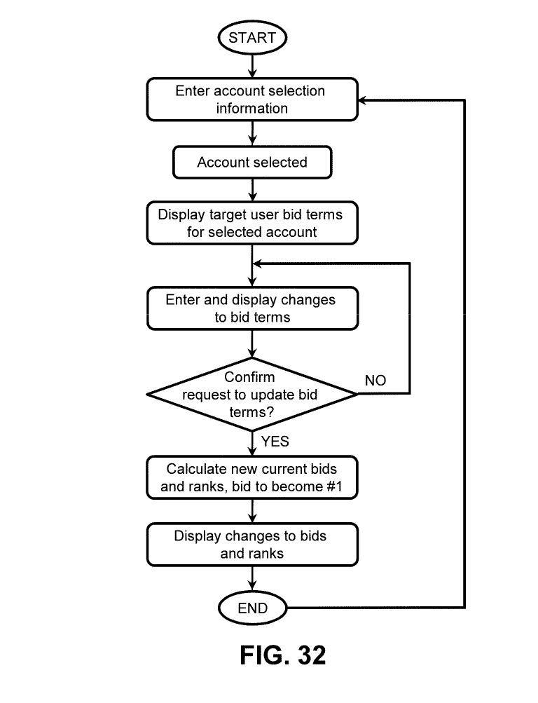

FIG. 32 is a flow chart illustrating a change bids process used in one embodiment of the disclosed system and method.

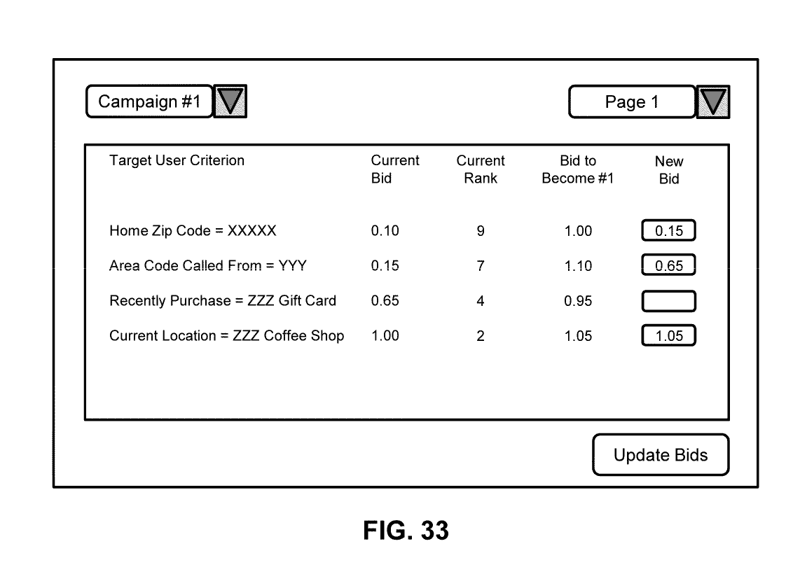

FIG. 33 illustrates an example of a screen display used in the change bids process of FIG. 32. Referring now to the drawings, FIG. 27 shows an example of a distributed system configured in a client/server architecture used in a preferred embodiment of the disclosed system and method. The BAMSGaS Client process requests and uses the BAMSGaS service without having to know any working details about the other server programs or the servers themselves. In networked systems, a client process usually runs on a computer or device that accesses shared network resources provided by another computer or device running a corresponding server process. However, it should also be noted that it is possible for the Client processes and the Server processes described here to run on the same computer or device, and for the distributed system to be configured in a peer-to-peer architecture.

A “server” is typically a remote computer system that is accessible over a communications medium such as the Internet. The client process may be active in a second computer system, and communicate with the server process over a communications medium that allows multiple clients to take advantage of the information-gathering and information-distribution capabilities of the server. Thus, the server essentially acts as an information provider for a computer network.

The block diagram of FIG. 27 therefore shows a distributed system comprising a plurality of user devices running the BAMSGaS Client application, a plurality of Advertiser/Content provider web servers, a plurality of Advertiser/Content provider client computers, and one or more BAMSGaS Account Management servers, all of which are connected to a network. The network shown in FIG. 27 may also include some or all of the elements of the Network Connectivity infrastructure platform shown in FIG. 25 or FIG. 26, with which users establish real-time or non-real-time interaction sessions with each other and access brand-supported user engagement content offerings.

Although an embodiment of the disclosed system and method may be specifically useful for mobile networks and the Internet, it should be understood that the user client devices, advertiser/content provider client computers, advertiser/content provider web servers, and account management servers may be connected together through one of a number of different types of networks. Such networks may include local area networks (LANs), wide area networks (WANs), regional networks such as commercial information services, wireless networks, and wireline networks. The client and server processes may even comprise different programs executing simultaneously on a single device or computer.

The advertiser/content provider client computers can be conventional personal computers (PCs), workstations, or computer systems of any other size. Each client computer typically includes one or more processors, memories, input/output devices, and a network interface. The advertiser/content provider web servers and BAMSGaS Account Management servers can be similarly configured. However, the advertiser/content provider web servers and BAMSGaS Account Management servers may each include many computers connected by a separate private network. In fact, the network may include hundreds or thousands of individual networks of computers.

The mobile subscriber client devices can execute the BAMSGaS Client program to establish real-time or non-real-time interaction sessions and to access advertisers' or other content providers' user engagement content offerings stored on advertiser/content provider servers. The BAMSGaS Client program allows the mobile subscribers to retrieve specific content using web addresses, also referred to as Uniform Resource Locators, or URLs. In addition, once content has been retrieved, the BAMSGaS Client program can provide access to other content when the user “clicks” on thumbnail representations, or representations in other formats, that translate into hyperlinks to other web content. Such hyperlinks provide an automated way for users to enter the URL of the desired content and to retrieve that content. The content can be in a variety of formats, including but not limited to complex digitally encoded multimedia content such as software programs, graphics, audio signals, videos, and so forth, designed and formatted for display on the mobile subscribers' devices.

In one embodiment of the disclosed system and method, shown in FIG. 27, mobile subscriber devices with the BAMSGaS Client program installed communicate through the network with each other and with various network information and content providers, including advertiser/content provider web servers. Advertiser/content provider client computers communicate through the network with various network information and content providers, including BAMSGaS Account Management servers and the advertiser's/content provider's own Web Content servers. User clients and advertiser/content provider clients communicate using the functionality provided by communication protocols such as a HyperText Transfer Protocol (HTTP), Session Initiation Protocol (SIP), Extensible Messaging and Presence Protocol (XMPP), although other communications protocols known in the art may also be used. Preferably, BAMSGaS Account Management servers and advertiser/content provider servers are accessible via Internet connection.

As discussed above and shown in FIG. 27, at least two types of servers are contemplated in various embodiments of the disclosed system and method. The first server contemplated is a BAMSGaS Account Management server comprising a computer storage medium and a processing system. A database is stored on the storage medium of the Account Management server. The database contains advertiser/content provider account information. It will be appreciated from the description below that the system and method of the present disclosed system and method may be implemented in software that is stored as executable instructions on a computer storage medium, such as memories or mass storage devices, on the Account Management servers. Conventional browser programs, running on advertiser/content provider client computers, may be used to access advertiser/content provider account information stored on Account Management servers. Preferably, access to the account management server is accomplished through a firewall, which protects the account management and bid-for-prominence result placement programs and the account information from external tampering. Additional security may be provided via security enhancements to the standard communications protocols.

A second server type contemplated is a Content web server. The BAMSGaS Client program permits mobile subscribers, upon establishing a real-time or non-real-time interaction session, to receive thumbnail lists or other representations of brand supported user engagement content offerings from the Content web server. Users can then submit requests for specific advertiser/content provider display backdrops, AURAs, and other multimedia content by clicking on the corresponding thumbnail or other representation and receiving the selected content on their device from the Content web server. Conventional browser programs, running on advertiser/content provider client computers, may be used to access advertiser/content provider content stored on Content web servers.

In one embodiment of the disclosed system and method, the BAMSGaS Client program displays a thumbnail list that includes relevant logos obtained from Content web servers and formatted by the results of the Pay-for-Prominence bidding process conducted by the BAMSGaS Account Management server. This list corresponds to hypertext links to display backdrops, AURAs, and other multimedia content relevant to target user metrics and criteria entered by advertisers/content providers using their client computers. The BAMSGaS Account Management server transmits this list as multimedia data, or in the form of a web page, to the mobile subscriber, where it is displayed by the BAMSGaS Client program or in a browser running on the mobile client device. The logo display list, an example of which is presented in FIG. 30, will be discussed below in further detail.

The servers may address the different information needs of the users located at client devices and computers. For example, one class of users located at advertiser/content provider client computers may be advertisers/content providers having brand-supported display backdrops or other multimedia content located on advertiser/content provider web servers. These advertisers/content providers may wish to access account information residing in storage on a BAMSGaS Account Management server. An advertiser/content provider may, through the account residing on the account management server, participate in a competitive bidding process with other advertisers/content providers. An advertiser/content provider may bid on any number of target user metrics or criteria relevant to the advertiser's/content provider's products or services. In one embodiment, the relevance of a bidded target user metric or criterion to an advertiser's/content provider's product or service is determined through a manual editorial process prior to insertion of the target user listing containing the target metric or criteria and advertiser web site URL into the database in the BAMSGaS Account Management server. In an alternate embodiment, the relevance of a bidded target user metric or criterion to an advertiser's/content provider's product or service may be evaluated using a computer program executing on the processing system of the BAMSGaS Account Management server, where the computer program will evaluate the user metric or criterion and corresponding display backdrop according to a set of predefined editorial rules.

The higher bids receive more prominent placement on icon list generated by the Pay-for-Prominence engine and displayed on the device of a user who matches the target metric or criterion bid on by the advertiser/content provider, and who activates a real-time interaction session. In an embodiment of the disclosed system and method, the amount bid by an advertiser/content provider comprises a money amount that is deducted from the account of the advertiser/content provider for each time the advertiser's/content provider's display backdrop is accessed via a hyperlink displayed on a user's device. In an alternative embodiment of the disclosed system and method, the amount bid by an advertiser/content provider comprises a money amount that is deducted from the account of the advertiser/content provider for each time the advertiser's/content provider's display backdrop is displayed for a pre-defined cumulative period of time on a user's device after being accessed via a hyperlink displayed on a user's device.

A user “clicks” on the icon providing the hyperlink, for example by tapping with a finger on a touch screen input, to initiate a retrieval request to retrieve the display backdrop or other multimedia content associated with the advertiser's/content provider's hyperlink. Preferably, each access or “click” on an icon hyperlink will be redirected to the corresponding advertiser's/content provider's content web server to associate the “click” with the account identifier for an advertiser. This redirect action, which is not apparent to the mobile user, will access account identification information coded into the icon list result before accessing the advertiser's/content provider's display backdrop using the result list hyperlink clicked on by the mobile user. The account identification information is recorded in the advertiser's/content provider's account along with information from the retrieval request as a retrieval request event. Since the information obtained through this mechanism conclusively matches an account identifier with a specific display backdrop or other multimedia content, accurate account debit records will be maintained. The advertiser's display backdrop description and icon hyperlink in the Pay-for-Prominence list result may be accompanied by an indication that the advertiser's listing is a paid listing.

A second class of users located at user client devices may be mobile subscribers engaged in a real-time interaction session using the BAMSGaS Client program and a network connectivity infrastructure platform. These mobile subscribers may be seeking display backdrops or other multimedia content to be used with AURAs of the users. A mobile subscriber may access an icon list result displayed on their device which provides links to display backdrops or other multimedia content for which the subscriber matches a corresponding target user metric or criterion. The mobile subscriber may click on the hypertext links associated with each icon on the list result to access the corresponding backdrops or other multimedia content. The hypertext links may access backdrops or other multimedia content anywhere on the Internet, and include paid backdrops or other multimedia content located on advertiser web servers.

In another embodiment, the BAMSGaS Client application may include a query box in which a mobile subscriber may enter a search term comprising one or more keywords describing display backdrops or other multimedia content for which they wish to search on advertiser/content provider web servers. Alternatively, a mobile subscriber may query a search engine web server from within the BAMSGaS Client application through a query box hyperlinked to the search engine web server. When the mobile subscriber has finished entering the search term, the subscriber may transmit the query to the search engine web server by clicking on a provided hyperlink. The search engine web server will then generate a search result icon list or web page and transmit this result to the mobile subscriber for display on their client device.

FIG. 28 is a diagram showing menus, display screens, and input screens presented to an advertiser/content provider accessing the BAMSGaS Account Management server through a conventional browser program to bid for a Pay-for-Prominence result in one embodiment of the disclosed system and method.

The advertiser/content provider, upon entering the URL of the BAMSGaS Account Management server into the browser program of their client computer in FIG. 27, invokes a login application as shown in FIG. 28, running on the processing system of the Account Management server. Once the advertiser/content provider is logged-in, the processing system provides a menu that has a number of options and further services for advertisers/content providers. These items, which will be discussed in more detail below, cause routines to be invoked to either implement the advertiser/content provider's request or request further information prior to implementing the advertiser/content provider's request. In one embodiment of the present disclosed system and method, the advertiser/content provider may access several options through a Main Menu, including requesting customer service, viewing user guidelines and policies, performing account administration tasks, adding funds to the advertiser/content provider's account, managing the account's advertising campaigns and target user profiles, viewing activity reports, and seeking context-specific help.

Access to the account information located on the Account Management server is restricted to users having an account record on the system, as only those users are provided with a valid login name and password. Password and login name information is stored along with the user's other account information in the database of the Account Management server, as shown in FIG. 27. Account information, including a login user name and password, is entered in the database of FIG. 27.

FIG. 29 is a diagram showing the types of information contained in each advertiser/content provider account record in the database. First, an advertiser/content provider account record contains a username and a password, used for online authentication as described above. The account record also contains contact information such as contact name, company name, street address, phone, e-mail address. Contact information is preferably utilized to direct communications to the advertiser/content provider when the advertiser/content provider has requested notification of key advertiser/content provider events under the notification option, discussed below. The account record also contains billing information such as current balance and credit card information. The billing information contains data accessed when the advertiser/content provider selects the option to add funds to the advertiser/content provider's account. In addition, certain billing information, such as the current balance, may trigger events requiring notification under the notification option.

The audit trail section of an account record contains a list of all events wherein the account record is accessed. Each time an account record is accessed or modified by an administrator or advertiser/content provider, a short entry describing the account access and/or modification event will be appended to the audit trail section of the administrator or advertiser/content provider account that initiated the event. The audit trail information may then be used to help generate a history of transactions made by the account owner under the account.

The advertising information section contains information needed to conduct the online Pay-for-Prominence bidding process, wherein the prominence in a list result generated by the BAMSGaS Account Management server is determined for an icon or other representation of a branded display backdrop or other multimedia content being bid for display on user devices by an advertiser/content provider. The advertising data for each user account may also be organized into one or more subaccounts, where each subaccount comprises at least one target user listing. Each target user listing corresponds to a bid on a user metric or criterion. An advertiser/content provider may utilize subaccounts to organize multiple bids on multiple target user metrics or criteria, or to organize bids for multiple display backdrops or other multimedia content. Subaccounts are also particularly useful for advertiser/content providers seeking to track the performance of targeted user segments. The subaccount superstructure is introduced for the benefit of the advertisers/content providers seeking to organize their advertising efforts, and does not affect the method of operation of the present disclosed system and method. Alternatively, the advertising information section need not include the added organizational layer of subaccounts, but may simply comprise one or more target user listings.

The target user listing corresponds to a user criteria/bid pairing and contains key information to conduct the online competitive bidding process. Preferably, each target user listing comprises the following information: user criterion or criteria, description of display backdrop or other multimedia content, URL for display backdrop or other multimedia content, bid amount, and a title. The user criteria comprise one or more keywords which may be common words in English (or any other language). Each keyword in turn comprises a character string. The target user criteria are the object of the competitive online bidding process. The advertiser/content provider selects target user criteria to bid on that are relevant to the products or services being promoted by the corresponding display backdrop or other multimedia content available from the advertiser's/content provider's content web server. Ideally, the advertiser/content provider may select target user criteria that are likely to be matched by mobile subscribers utilizing the real-time interaction service, although less common target user criteria may also be selected to ensure comprehensive coverage of target users for bidding.

The display backdrop description is a short textual description (preferably less than 140 characters) of the display backdrop or other multimedia content being offered by the advertiser/content provider to users of the real-time interaction service, and may be displayed as part of the advertiser/content provider's entry in a Pay-for-Prominence result list. The target user listing may also contain a title for the display backdrop or other multimedia content that may be displayed as the hyperlinked heading to the advertiser/content provider's icon entry in a bid result list. The URL contains the Uniform Resource Locator address of the display backdrop or other multimedia content on the advertiser/content provider's content web server. When the user clicks on the hyperlink/icon provided in the advertiser/content provider's bid result list entry, the URL is provided to the BAMSGaS Client or a browser program on the user's device. The BAMSGaS Client or browser program, in turn, accesses the advertiser/content provider's content web server through the redirection mechanism discussed above. The URL may also be displayed as part of the advertiser/content provider's entry in a bid result list.

The bid amount preferably is a money amount bid by an advertiser/content provider for a Pay-for-Prominence listing. This money amount is deducted from the advertiser/content provider's prepaid account balance or is recorded for advertiser/content provider accounts that are invoiced for each time a display backdrop is selected and displayed by a user matching the corresponding target user criteria who clicks on the bid result list hyperlink and retrieve the corresponding content from the advertiser/content provider's content web server.

Finally, a rank value is a value generated dynamically, preferably by the processing system of the BAMSGaS Account Management server shown in FIG. 27, each time an advertiser/content provider places a bid. The rank value of an advertiser/content provider's content listing determines the placement location of the advertiser/content provider's entry in the bid result list generated when a real-time interaction session is initiated by a user matching the target user criteria. The rank value may be an ordinal value determined in a direct relationship to the bid amount; the higher the bid amount, the higher the rank value and the more prominent the placement on the bid result list. Most preferably, the rank value of 1 is assigned to the highest bid amount with successively higher ordinal values (e.g., 2, 3, 4, . . . ) associated with successively lower ranks and assigned to successively lower bid amounts. In various embodiments of the present disclosed system and method, the level of prominence of an advertiser's/content provider's thumbnail representations, or representations in other formats, of their logos or display backdrop offerings may be determined by mapping the rank value to one or more attributes, including but not limited to the following: The position on a scrollable list displayed on a targeted user's device; the position in a continuously scrolling list displayed on a targeted user's device; the speed at which the advertiser's thumbnail scrolls in a continuously scrolling list displayed on a targeted user's device; the size/display area (in pixels-by-pixels) of the advertiser's thumbnail; presentation of colored vs. grey-scale or black and white versions of the advertiser's thumbnail.

The “Account Administration” menu of FIG. 28 includes a selection enabling an advertiser/content provider to set notification options. Under this selection, the advertiser/content provider may select options that will cause the system to notify the advertiser/content provider when certain key events have occurred. For example, the advertiser/content provider may elect to set an option to have the system send conventional electronic mail messages to the advertiser/content provider when the advertiser/content providers account balance has fallen below a specified level. In this manner, the advertiser/content provider may receive a “warning” to replenish funds in the account before the account is suspended (meaning the advertiser/content provider's listings will no longer appear in target user bid result lists). Another key event for which the advertiser/content provider may wish notification is a change in position of an advertiser/content provider's listing in the target user result list generated for a particular target user criterion. For example, an advertiser/content provider may wish to have the system send a conventional electronic mail message to the advertiser/content provider if the advertiser/content provider has been outbid by another advertiser/content provider for a particular target user criterion (meaning that the advertiser/content provider's listing will appear with lower prominence than previously). When one of the system-specified key events occurs, a database search is triggered for each affected target user listing. The system will then execute the appropriate notification routine in accordance with the notification options specified in the advertiser/content provider's account.

When a mobile user accesses the BAMSGaS Client program and initiates a real-time interaction session according to the procedure described previously, the BAMSGaS Account Management preferably generates and delivers a target user bid result list where the “canonicalized” target user entries in each target user listing exactly matches the canonicalized user profile generated by the BAMSGaS Client program. The canonicalization of target user metrics or criteria used in Pay-for-Prominence listings removes common irregularities of terms entered by advertisers/content providers, such as capital letters and pluralizations, in order to generate relevant results. However, alternate schemes for determining a match between the target user search term field of the target user listing and the user profile generated by the BAMSGaS Client program are well within the scope of the present disclosed system and method. For example, string matching algorithms known in the art may be employed to generate matches where key words of the target user metric/criterion listing have the same root but are not exactly the same (e.g., computing vs. computer). Alternatively a thesaurus database of synonyms may be stored on the BAMSGaS Account Management server, so that matches may be generated for a target user search term having synonyms. Localization methodologies may also be employed to refine certain searches. For example, a search for “baseball team” or “coffee shop” may be limited to those advertisers/content providers within a selected city, zip code, or telephone area code. This information may be obtained through a cross-reference of the advertiser/content provider account database stored in the storage system on the BAMSGaS Account Management server. Finally, internationalization methodologies may be employed to refine searches for users outside the United States. For example, country or language-specific search results may be generated, by a cross reference of the advertiser/content provider account database, for example.

In one example, the target user bid result list may be display bids from advertisers targeting male users and offering clothing brand related display backdrops. In the example, each entry in the bid result list consists of a hyperlinked logo icon that, when clicked by a mobile user, retrieves the corresponding display backdrop from the advertiser/content provider's URL where the selected content is located. In addition to an icon, each list entry may include a description of the backdrop/content, preferably comprising a title and a short textual description, in addition to the hyperlink. The URL may also be displayed in the bid result list entry. The “click through” of a bid result item occurs when the mobile user viewing the bid result list of FIG. 30 selects, or “clicks” on the hyperlinked logo or other representation and retrieves/displays the corresponding backdrop to be viewed by another user or other users in the same real-time interaction session, as shown on FIG. 31. In order for a “click through” to be completed, the user's click should be recorded at the BAMSGaS Account Management server and redirected to the Advertiser/Content provider's URL via the redirect mechanism discussed above.

The bid result list entries shown in FIG. 30 may also show the rank value of the advertiser/content provider's target user listing. The rank value is an ordinal value, preferably a number, generated and assigned to the target user listing by the bid-for-prominence processing system of FIG. 27. Preferably, the rank value is assigned through a process, implemented in software that establishes an association between the bid amount, the rank, and the target user term of a target user listing. The process gathers all target user listings that match a particular target user term, sorts the target user listings in order from highest to lowest bid amount, and assigns a rank value to each target user listing in order. The highest bid amount receives the highest rank value, the next highest bid amount receives the next highest rank value, proceeding to the lowest bid amount, which receives the lowest rank value. Most preferably, the highest rank value is 1 with successively increasing ordinal values (e.g., 2, 3, 4, . . . ) assigned in order of successively decreasing rank. Preferably, if two target user listings having the same target user term also have the same bid amount, the bid that was received earlier in time will be assigned the higher rank value. Unpaid listings may also be displayed, for example following the lowest-ranked paid listing. Preferably, unpaid listings are displayed if there are an insufficient number of listings to fill the available slots in a target user display area or results page. Unpaid listings may be generated by a target user engine utilizing objective distributed database and text searching algorithms known in the art.

As shown in the Advertising Campaign Management menu of FIG. 28, several choices are presented to the advertiser/content provider to manage target user listings. In the “Change a Bid or Bids” selection, the advertiser/content provider may change the amount bid for one or more target user listings currently in the account. The process invoked by the system for the change bids function is shown in FIG. 32. After the advertiser/content provider indicates the intent to change bids by selecting the “Change a Bid or Bids” menu option, the system searches the user's account in the database and displays the target user listings for the entire account or a default subaccount in the advertiser/content provider's account. Target user listings may be grouped into subaccounts defined by the advertiser/content provider, and each subaccount may comprise one or more target user listings. One or more subaccounts may be displayed simultaneously, and the display should also preferably permit the advertiser/content provider to view the target user listings for one or more selected subaccounts.

An example of a screen display shown to the advertiser/content provider in order to enable bid changes is shown in FIG. 33 and will be discussed below. To change bids, the advertiser/content provider user may specify new bids for target user terms for which the advertiser/content provider already has an existing bid by entering a new bid amount into the new bid input field for the target user term. The advertiser/content provider-entered bid changes are displayed to the advertiser/content provider as shown in FIG. 32. After viewing the entered bid change for a display backdrop prominence listing, the advertiser/content provider confirms their request to update their bid with these changes. The advertiser/content provider may transmit such a request to the BAMSGaS Account Management server by a variety of means, including clicking on a button graphic.

As shown in FIG. 32, upon receiving the request to update the advertiser/content provider's bids, the system calculates the new current bid amounts for every target user listing displayed, the new rank values, and the new bid amount needed to become the highest ranked target user listing matching the target user profile. Preferably, the system then presents a display of these changes. After the advertiser/content provider confirms their changes, the system updates the persistent state by writing the changes to the corresponding advertiser/content provider account in the database.

As shown in FIG. 33, the target user listing data can be displayed in tabular format, with each target user listing corresponding to one row of the table. Each target user criterion is displayed in the leftmost column, followed by the current bid amount, and the current rank of the target user listing. The current rank is followed by a column entitled “Bid to become #1”, defined as the bid amount needed to become the highest ranked target user listing for the displayed target user criterion. The rightmost column of each row comprises a new bid input field which is set initially to the current bid amount.

As shown in FIG. 33, the target user listings may be displayed as “subaccounts.” Each subaccount comprises one target user listing group, with multiple subaccounts residing within one advertiser/content provider account. Each subaccount may be displayed on a separate display page having a separate page. The advertiser/content provider should preferably be able to change the subaccount being displayed by manipulating a pull-down “Campaign #” menu on the display shown in FIG. 33. In addition, target user listing groups that cannot be displayed completely in one page may be separated into pages which may be individually viewed by manipulating the pull-down menu. Again, the advertiser/content provider should preferably be able to change the page displayed by clicking directly on a pull-down menu located on the display page of FIG. 33. The advertiser/content provider may specify a new bid for a displayed target user listing by entering a new bid amount into the new bid input field for the target user listing. To update the result of the advertiser/content provider-entered changes, the advertiser/content provider clicks on button graphic to transmit an update request to the account management server, which updates the bids as described above.

Many of the other selections listed in the “Advertising Campaign Management” menu of FIG. 28 function as variants of the “Change Bid or Bids” function described above. For example, if the advertiser/content provider selects the “Change Prominence Ranking” option, the advertiser/content provider may be presented with a display similar to the display of FIG. 33 used in the “Change Bid or Bids” function. However, in the “Change Prominence Ranking” option, the “New Bid” field would be replaced by a “New Rank” field, in which the advertiser/content provider enters the new desired prominence rank position for a target user listing term. After the advertiser/content provider requests that the ranks be updated, the system then calculates a new bid price by any of a variety of algorithms easily available to one skilled in the art. For example, the system may invoke a routine to locate the target user listing in the target user database having the desired rank/target user term combination, retrieve the associated bid amount of said combination, and then calculate a bid amount that is N cents higher; where N=1, for example. After the system calculates the new bid price and presents a read-only confirmation display to the advertiser/content provider, the system updates the bid prices and rank values upon receiving approval from the advertiser/content provider.

The “Modify a Listing Component” selection on the Advertising Campaign Management menu of FIG. 28 may also generate a display similar to the format of FIG. 33. When the advertiser/content provider selects the “Modify a Listing Component” option, the advertiser/content provider may input changes to the URL, title, or description of a target user listing via web-based forms set up for each target user listing. Similar to the process discussed above, the forms for the URL, title, and description fields may initially contain the old URL, title and description as default values. After the advertiser/content provider enters the desired changes, the advertiser/content provider may transmit a request to the system to update their account with these changes. The system then displays a read-only confirmation screen, and then writes the changes to the persistent state (e.g., the user account database) after the advertiser/content provider approves the changes.

A process similar to those discussed above may be implemented for changing any other peripheral options related to a target user listing; for example, changing the matching options related to a bidded target user term. Any recalculations of bids or ranks required by the changes may also be determined in a manner similar to the processes discussed above.

In the “Delete Bidded Target User Criteria” option, the system retrieves all of the target user listings in the account of the advertiser/content provider and displays these target user listings in an organization and a format similar to the display of FIG. 33. Each target user listing entry may include, instead of the new bid field, a check box for the advertiser/content provider to click on. The advertiser/content provider would then click to place a check or (X) mark next to each target user term to be deleted, although any other means known in the art for selecting one or more items from a list on a web page may be used. After the advertiser/content provider selects all the target user listings to be deleted and requests that the system update the changes, the system preferably presents a read-only confirmation of the requested changes, and updates the advertiser/content provider's account only after the advertiser/content provider approves the changes. The “deleted” target user listings are removed from the target user database and will not appear in subsequent searches. However, the target user listing will remain as part of the advertiser/content provider's account record for billing and account activity monitoring purposes.

In the “Add Bidded Target User Criteria” option, the system provides the advertiser/content provider with a display having a number of entry fields corresponding to the elements of a target user listing. The advertiser/content provider then enters into each field information corresponding to the respective target user listing element, including the search term, the web content URL, the web content title, the web content description, and the bid amount, as well as any other relevant information. After the advertiser/content provider has completed entering the data and has indicated thus to the system, the system returns a read-only confirmation screen to the advertiser/content provider. The system then creates a new target user listing instance and writes it into the account database and the target user database upon receiving approval from the advertiser/content provider.

Preferably, the “Advertising Campaign Management” menu of FIG. 28 provides a selection for the advertiser/content provider to “Get Suggestions for Bidded Target User Criteria”. In this case, the advertiser/content provider enters a bidded target user term into a form-driven query box displayed to the advertiser/content provider. The system reads the target user term entered by the advertiser/content provider and generates a list of additional related target user terms to assist the advertiser/content provider in locating target user terms relevant to the display backdrop or other multimedia content being offered to mobile users by the advertiser/content provider. Preferably, the additional target user terms are generated using methods such as a string matching algorithm applied to a database of bidded target user terms and/or a thesaurus database implemented in software. The advertiser/content provider may select target user terms to bid on from the list generated by the system. In that case, the system displays to the advertiser/content providers the entry fields described above for the “Add Bidded Target User Criteria” selection, with a form for entering a target user listing for each term selected. Preferably, the selected target user term is inserted as a default value into the form for each target user listing. Default values for the other target user listing components may also be inserted into the forms if desired.

The “Advertising Campaign Management” menu of FIG. 28 also preferably provides advertiser/content providers with a “Calculate Expense Projection for a Bid” selection. In this selection, the advertiser/content provider specifies a target user listing or subaccount for which the advertiser/content provider would like to predict a “daily run rate”, a “days remaining to expiration”, or other such projection. The system calculates the projections based on a cost projection algorithm, and displays the predictions to the advertiser/content provider on a read-only screen. The predictions may be calculated using a number of different algorithms known in the art. However, since the cost of a target user listing is calculated by multiplying the bid amount by the total number of clicks received by the target user listing, or cumulative display time for the corresponding display backdrop, at that bid amount during a specified time period, every cost projection algorithm must generally determine an estimated number of clicks or cumulative display time per month (or other specified time period) for a target user listing. The clicks on a target user listing or cumulative display time for a display backdrop may be tracked via implementation of a software counting mechanism as is well known in the art. Clicks and cumulative display times for all target user listings may be tracked over time, and this data may be used to generate estimated numbers of clicks per month or cumulative display times for individual target user listings. For a particular target user term, an estimated number and duration of user accesses per day can be determined and multiplied by the cost of a click or specific duration. This product can then be utilized to project a daily run rate. The current balance may be divided by the projected daily run rate to obtain a projected number of days to exhaustion or “expiration” of account funds.

One embodiment of the disclosed system and method bases the cost projection algorithm on a simple predictor model that assumes that every target user term performs in a similar fashion. This model assumes that the rank of the advertiser/content provider's target user listing will remain constant and not fluctuate over time. This algorithm has the advantages of being simple to implement and fast to calculate. The predictor model is based on the fact that the click through rate, e.g. the total number of clicks, or referrals, for a particular target user listing, is considered to be a function of the rank of the target user listing. The model therefore assumes that the usage curve of each target user term, that is, the curve generated by plotting the number of clicks on a target user listing against the rank of the target user listing, is similar to the usage curve for all target user terms. Thus, known values extrapolated over time for the sum of all clicks for all target user terms, the sum of all clicks at a given rank for all target user terms, and the sum of all clicks for the selected target user term may be employed in a simple proportion to determine the total of all clicks for the given rank for the selected target user term. The estimated daily total of all clicks for the selected target user term at the selected rank is then multiplied by the advertiser/content provider's current bid amount for the target user term at that rank to determine a daily expense projection. In addition, if particular target user terms or classes of target user terms are known to differ markedly from the general pattern, correction values specific to the target user term, advertiser/content provider, or other parameter may be introduced to fine-tune the projected cost estimate.

Yet another embodiment of the disclosed system and method implements an option for context specific help that the advertiser/content provider may request at any time the advertiser/content provider is logged in. The help option may be implemented as a small icon or button located on the system generated display page. The advertiser/content provider may click on the icon or button graphic on the display page to request help, upon which the system generates and displays a help page keyed to the function of the particular display the user is viewing. The help may be implemented as separate display pages, a searchable index, dialog boxes, or by any other methods well known in the art.

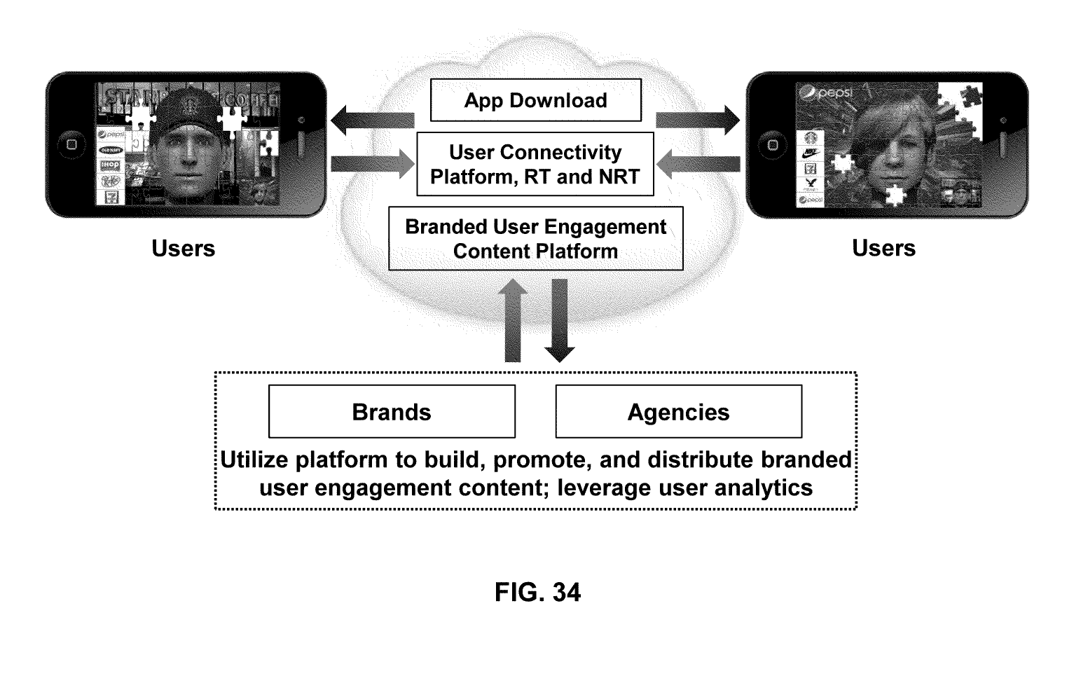

FIG. 34 illustrates the user interaction and brand engagement functions enabled by the BAMSGaS platform, by combining a consumer smartphone app with an enterprise-grade, on-demand, Platform as a Service solution for brands and their agencies to engage consumers “face-to-brand” via branded display backdrops, AURAs, and other multimedia content. This highly differentiated user engagement mode has the benefit of being effective across a broad spectrum of user demographics and brands.

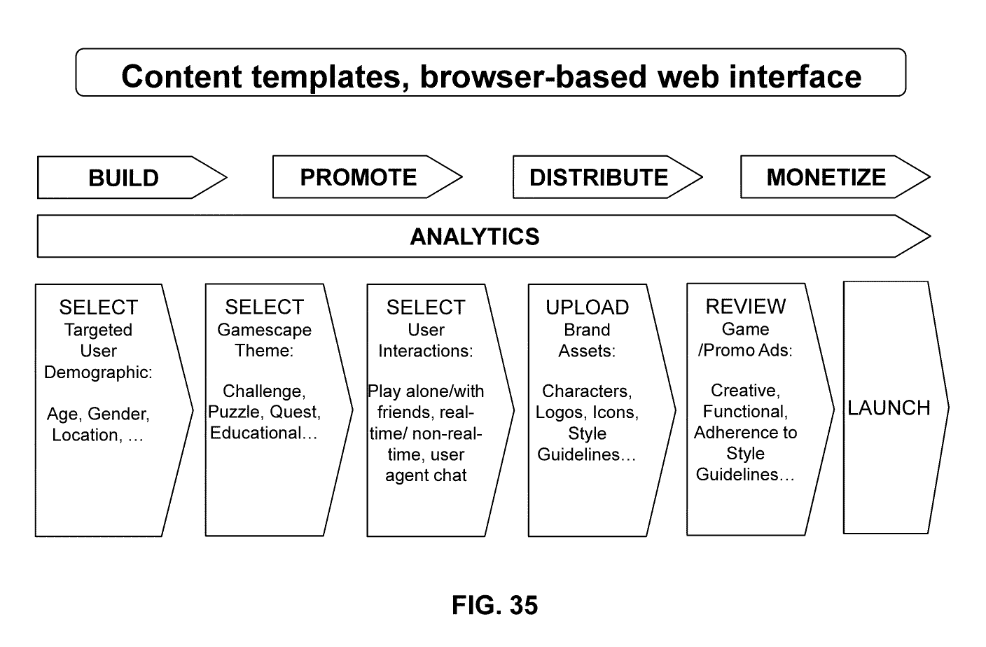

FIG. 35 illustrates a cloud-based platform-as-a-service deployment of the BAMSGaS platform. In one embodiment, brands and other content providers may manage the platform via a web interface that makes it simple to access a comprehensive library of brand-asset-ready display backdrop templates, and to select target user demographics, backdrop themes, and user interaction modes. They are then able to upload brand assets like logos, AURA characters, icons and style guidelines, review the final user engagement content offering and supporting promotional materials, launch and promote it on the BAMSGaS platform. In various embodiments brands and other content providers are able to leverage detailed user analytics to drive Pay-for-Prominence bidding decisions. In comparison to alternative modes of user engagement such as a traditional mobile ad campaign or custom development of a single branded mobile game, the BAMSGaS platform allows brands and advertisers to quickly build, deploy, and drive monetization from collections of branded display backdrops, AURAs, and other multimedia content that engage a broad spectrum of consumer demographics, while leveraging behavioral targeting, partnerships and promotions.

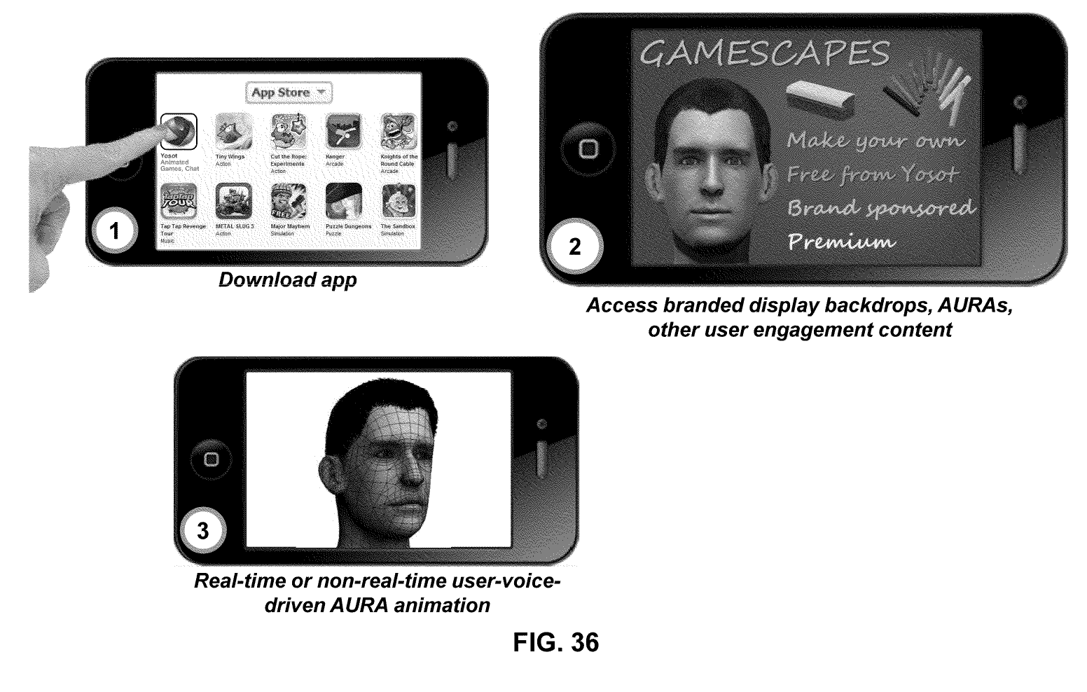

FIG. 36 illustrates mobile user access to branded engagement content enabled by the BAMSGaS application and platform. Mobile users download the BAMSGaS app to gain access to branded display backdrops, AURAs, and other multimedia content that they can then utilize during real-time animated chat and non-real-time animated messaging sessions. In various embodiments, users are also provided with access to in-app purchases of premium display backdrops, AURAs, add-on features for both backdrops and AURAs, and real and virtual goods.

The foregoing detailed description should be regarded as illustrative rather than limiting and the appended claims, including all equivalents, are intended to define the scope of the disclosed system and method.

What is claimed is:

1. A method for advocating brands in a mobile social game for users implemented on a processor, the method comprising:
converting a digital photograph or sequence of video frames into an animated user representation, creating a new animated user representation, or selecting an existing animated user representation;
identifying face and facial features of said digital photograph or sequence of video frames;
linking facial features of the photograph or sequence of video frames to the animated user representation;
analyzing a user voice and extracting a plurality of phonemes and time stamps;
mapping the extracted phonemes to a fixed set of facial expressions;
animating one or more facial features on the animated user representation by synchronizing movements of the facial expressions to the extracted phonemes using the time stamps.

2. The method of claim 1, further comprising:
providing a plurality of brand supported display backdrops;
allowing a user to select the backdrop to be displayed.

3. The method of claim 1, further comprising:
allowing a plurality of users to interact with each other over a network using a combination of voice communications and the animated representations.

4. The method of claim 1, further comprising:
Activating an audio background to be played during an interactive user session, in addition to or instead of a branded display backdrop by selecting from a list of thumbnail representations of a performer, a song, a album, a genre or other audio background selection criteria displayed on a user's display screen.

5. The method of claim 1, further comprising:
providing advertisers and other brand content providers access to an account management and bidding platform that facilitates targeting users and bidding online in a competitive process to deliver users branded display backdrops, branded animated user representations, and other branded multimedia content.

6. The method of claim 5, further comprising:
allowing each advertiser or brand content provider to bid on one or more specific combinations of: a target user criteria, a branded display backdrop, a branded animated user representation, or other branded multimedia content to offer to the user.

7. The method of claim 5, further comprising:
coupling advertiser bids and display prominence so that the higher the bid, the more prominent is the presentation of an advertiser's thumbnail, icon or other representation of the advertiser's user engagement content offering in a list displayed on a target user's multimedia device.

8. The method of claim 5, further comprising:
allowing an advertiser or other brand content provider to select one or more criterion or metrics that define the users they wish to target and determining the prominence of presenting a brand icon within a list of icons displayed on multimedia devices of the targeted users by participating in an online competitive bidding process.

9. A system for advocating brands in a mobile social game, comprising:
a network accessible computer software application having a user input interface configured for:
inputting a user's digital photograph or sequence of video frames and voice,
identifying face and facial features of said photograph or sequence of video frames,
creating a new, or selecting an existing locally stored animated user representation,
linking facial features of the photograph or sequence of video frames to animated user representation,
extracting a plurality of phonemes and time stamps from a user's voice,
mapping the extracted phonemes to a fixed set of facial expressions; and
animating one or more facial features on the animated representation by synchronizing movements of the facial features to the extracted phonemes using the time stamps; and
a software module which interfaces with a network to allow a plurality of users to interact with each other using a combination of voice communications and the animated user representations.

10. The system of claim 9, further comprising:
a network accessible database comprising a plurality of branded or unbranded display backdrops, animated user representations, and multimedia content.

11. The system of claim 9, further comprising:
a network accessible database comprising audio content to be played during an interactive user session, in addition to or instead of a branded display backdrop, by selecting from a list of thumbnail representations of a performer, a song, a album, a genre or other audio background selection criteria displayed on a user's display screen.

12. The system of claim 9, further comprising:
a multimedia device which comprises:
a processor
a camera,
a display,
a microphone,
a speaker or headphones, and
a storage device.

13. The system of claim 9, further comprising:
an interface to provide advertisers and other brand content providers access to an account management and bidding platform that facilitates targeting users and bidding online in a competitive process to deliver users branded display backdrops, animated user representations, and other multimedia content.

14. A non-transitory computer readable medium storing computer-executable process steps for providing resources to participants over an electronic network, said process steps comprising:
converting a digital photograph or sequence of video frames into an animated user representation, creating a new animated user representation, or selecting an existing animated user representation;
identifying face and facial features of said photograph or sequence of video frames,
linking facial features of the photograph or sequence of video frames to animated user representation,
extracting a plurality of phonemes and time stamps from a user's voice,
mapping the extracted phonemes to a fixed set of facial expressions; and
animating one or more facial features on the animated user representation by synchronizing movements of the facial features to the extracted phonemes using the time stamps,
providing a plurality of branded or unbranded display backdrops;
allowing a user to select the backdrop to be displayed;
wherein said converting, identifying, linking, extracting, analyzing, mapping, animating, providing, and displaying are performed by a processor.

15. The non-transitory computer readable medium according to claim 15, said process steps further comprising:
allowing a plurality of users to interact with each other over a network using a combination of voice communications and the animated user representations;
wherein said animated representations are created by a processor.

16. The non-transitory computer readable medium according to claim 15, said process steps further comprising:
providing advertisers and other brand content providers access to an account management and bidding platform that facilitates targeting users and bidding online in a competitive process to deliver users branded display backdrops, branded animated user representations, or other branded content;
wherein said providing is performed using a processor.

17. The non-transitory computer readable medium according to claim 15, said process steps further comprising:
allowing each advertiser or brand content provider to bid on one or more specific combinations of: a target user criteria, a branded display backdrop, a branded animated user representation, or other branded multimedia content to offer to the user;
wherein said bidding is performed using a processor.

18. The non-transitory computer readable medium according to claim 15, said process steps further comprising:
coupling advertiser bids and display prominence so that the higher the bid, the more prominent is the presentation of an advertiser's thumbnail, icon or other representation of the advertiser's user engagement content offering in a list displayed on a target user's multimedia device;
wherein said coupling is performed using a processor.

19. The non-transitory computer readable medium according to claim 15, said process steps further comprising:
allowing an advertiser or other brand content provider to select one or more criterion or metrics that define the users they wish to target and determining the prominence of presenting of a brand icon within a list of icons displayed on multimedia devices of the targeted users by participating in an online competitive bidding process;
wherein said bidding is performed using a processor.

20. A method for reducing the computational complexity, bandwidth requirements, and network infrastructure required to support real-time animated chat and non-real-time animated messaging for user interaction and brand engagement performed on a processor, comprising:
analyzing a sending user's voice to generate a fixed set of phonemes, other units of speech, emotional clues, or other information extracted from the user's voice, together with a set of time stamps corresponding to each such phoneme;
mapping the fixed set of phonemes, other units of speech, emotional clues, or other information extracted from a user's voice to a fixed set of identifiers for animated user representation facial expressions;
generating a very low bandwidth data stream that includes only the sequence of facial expression identifiers and the corresponding time stamps relative to the sending user's voice signal;
transmitting the very low bandwidth data stream to the receiving user along with the sender's voice signal;
rendering a set of animated user representation facial expressions and a display backdrop locally stored on the receiving user's device in synchronism with the received voice signal using the facial expression identifiers and time stamps.
